(19) United States
(12) Patent Application Publication
(10) Pub. No.: US 2007/0022375 A1
(43) Pub. Date: Jan. 25, 2007

(54) APPARATUS, SYSTEM, AND METHOD FOR AN ELECTRONIC PAYMENT SYSTEM

(75) Inventor: David H. Walker, Atlanta, GA (US)

Correspondence Address: MORGAN & FINNEGAN, L.L.P., 3 WORLD FINANCIAL CENTER, NEW YORK, NY, 10281-2101, US

(73) Assignee: David H. Walker, Atlanta, GA (US)

(21) Appl. No.: 11/532,262

(22) Filed: Sep. 15, 2006

Related U.S. Application Data
(63) Continuation of application No. 09/691,927, filed on Oct. 19, 2000.

(51) Int. Cl. G06F 15/00

(52) U.S. Cl. 715/513; 705/35; 705/38

(57) ABSTRACT

The present contrivance is an apparatus, system, and method for an electronic payment system. The present contrivance provides an electronic payment system that provides advertising for compensation. Further the present contrivance provides an anonyfier that can separate accesser identity information from transaction information. Further, the present contrivance provides an advertising targeting system that determines advertising that does not conflict with providers provisions. Further, the present contrivance provides a payment release system based on delivery verification. Further, the present contrivance provides a credit auction providing accessers and creditors with a dynamic credit market. The present contrivance also provides a system that converts identification cards and other forms of ID into non repudiation devices. The present contrivance also enables the extension of closed loop payment systems.

This application is a continuation of co-pending application Ser. No. 09/691,927, filed Oct. 19, 2000.

### FIELD

The present contrivance generally relates to computer systems and software, and more particularly to a method and system for making payments and obtaining credit.

### BACKGROUND

Information Technology Systems

Typically, users (i.e., people or other systems) engage computers to facilitate information processing. A computer operating system enables and facilitates users to access and operate computer information technology. Information technology systems provide interfaces that allow users to access and operate the various systems.

User Interface

Somewhat like how automobile operator interfaces (e.g., steering wheels, gearshifts, speedometers, etc.) facilitate the access, operation, and display of automobile resources, functionality, and status; computer user interfaces similarly facilitate (e.g., via cursors, menus, windows, etc.) the access, operation, and display of computer hardware and operating system resources, functionality, and status. Graphical user interfaces such as the Apple Macintosh Operating System or Microsoft's Windows provide a baseline and means of accessing and displaying information. Such consumer-oriented operating systems enable users to access and operate computer information technology by providing an integrated user interface. Other operating systems such as Unix do not provide integrated graphical user interfaces and instead allow various interfaces to be employed such as command line interfaces (e.g., C-shell) and graphical user interfaces (e.g., X windows).

World Wide Web

The proliferation and expansion of computer systems, databases, the Internet, and particularly the World Wide Web (the web), have resulted in a vast and diverse collection of information. Various user interfaces that facilitate the interaction of users with information technology systems (i.e., people using computers) are currently in use. Tim Berners-Lee originally developed an information navigation interface called WorldWideWeb.app, i.e., the web, in late 1990 on NeXT Computer Inc.'s operating system, NeXTSTEP, at the European Organization for Nuclear Research (CERN, a particle physics center). Subsequently, information navigation interfaces, i.e., web browsers, have become widely available on almost every computer operating system platform.

Generally, the web is the manifestation and result of a synergetic interoperation between user interfaces (e.g., web browsers), servers, distributed information, protocols, and specifications. Web browsers were designed to facilitate navigation and access to information, while information servers were designed to facilitate provision of information. Typically, web browsers and information servers are disposed in communication with one another through a communications network; i.e., information servers typically provide information to users employing web browsers for navigating and accessing information about the web. Microsoft's Internet Explorer and Netscape Navigator are examples of web browsers. In addition, navigation user interface devices such as WebTV have also been implemented to facilitate web navigation. Microsoft's Information Server and Apache are examples of information servers; i.e., their function is to serve information to users that typically access the information by way of web browsers.

Hypertext

Information on the web typically is provided through and distributed employing a HyperText Markup Language (HTML) specification. HTML documents are also commonly referred to as web pages. HTML documents may contain links to other HTML documents that can be traversed by users of web browsers (i.e., user interfaces) by selecting the links, which are commonly highlighted by color and underlining. HTML has been extended and upgraded resulting in new standards such as Extensible Markup Language (XML) and other such variants, which provide greater functionality. HTML's progenitors were Standardized General Markup Language (SGML), which in turn was preceded by the General Markup Language (GML). SGML is generally regarded as a more functional superset of HTML and first appeared in 1980 as a draft by the Graphic Communications Association (GCA) to the American National Standards Institute (ANSI) (GCA 101-1983); it was adopted as an international standard by the International Standards Organization (ISO) in 1986 (ISO 8879:1986). Charles Goldfarb, Edward Mosher, and Raymond Lorie invented the GML at IBM to facilitate law office information system integration and improve document processing. GML itself was inspired by William Tunnicliffe, chairman of the CGA, during a presentation on the topic of “the separation of the information content of documents from their format” at the Canadian Printing Office in September, 1967.

HTML documents typically are accessed through navigation devices via a HyperText Transfer Protocol (HTTP). HTTP is a stateless application-level protocol for distributed, collaborative, hypermedia information systems, and is further described at the World Wide Web Consortium organization (W3C) web site entitled HTTP Specifications and Drafts (available at www.w3.org/Protocols/Specs.html). Microsoft's Information Server allows the tracking of a state with a built-in session object.

The basic web browsing paradigm presents users with a scrolling page full of text, pictures, and various other forms of information media such as movies and links to other documents. Web browsers allow users to access uniquely identified HTML documents on the web by entering a navigation location in a Universal Resource Locator (URL) and employing HTTP as a transfer protocol to provide and obtain web pages. Typically, a user provides the address of a desired HTML document into a URL (either directly or through the selection of links in an already viewed HTML document).

Payment Systems

There has been a tremendous increase in transactions occurring through communications networks such as the Internet. This increase in transactions has coincided with an increase in the use of electronic payment systems.

Historically, payments were enabled by a double coincidence of wants; i.e., barter for goods and or services. Thereafter, physical commodities such as silver, gold, etc. were affected as a medium to enable transaction where no double coincidence of wants existed. Thereafter, commodity backed currency, and thereafter fiat money (i.e., non commodity backed currency) became the medium of ad hoc payment systems throughout the world.

Later, bank notes came into existence that allowed people to employ their own medium facilitating a transfer of funds from one person's bank account into another; a clearing process employed by participating banks established the validity of the notes, and enabled the release and transfer of funds. These notes (and analogue giros) would be brought to a clearing house where banks would meet to exchange the notes and enable the transfer of funds.

Eventually, this cumbersome physical meeting process was automated into automated clearing house payments. These automated clearing house systems required the transfer of tapes and or the like, and have eventually been effectuated over communications networks. The automated clearing house systems required participants to adopt rigid open standards such as the electronic data interchange (EDI) community standard, but still worked similarly to their centralized clearing house analogues of yore.

As transaction needs increased, new payment methods were developed. Significantly, payment cards first were developed around 1915 and were employed by a small number of U.S. hotels and department stores. In 1947, the Flatbush National Bank began offering cards to customers, which was soon followed by the Diners Club card in 1950.

Since then, many card companies have come into existence, and were made available employing two major payment system methods: closed and open loop payment processes.

Cards such as American Express, Discover, and Diners Club employ a closed loop system. A closed loop system is one where all transaction data is captured within the system and employs a single owner that has contracts with all cardholders and merchants employing the system. The single owner authorizes and settles all transactions. The single owner also obtains a fee, typically from the merchant, for enabling the transaction.

Alternatively, cards such as Visa and MasterCard employ an open loop system. An open loop system is one where a joint venture of participants enables a transaction.

A cardholder may obtain a credit card from any number of issuers (typically banks). Similarly, merchants who wish to accept business from cardholders and, thus, must find a sponsoring bank that participates in the joint venture. When a cardholder engages in a transaction with a merchant, the transaction is facilitated through the joint venture's centralized authorization and settlement system.

The open loop payment system provides the details of the transaction to the issuer and executes the transfer of charges between the issuer and sponsor. Each issuer sets its own fees for enabling such transactions, typically, the brunt transaction charge being born upon the merchants. Also, the joint venture payment system sets a price, i.e., an interchange fee, that determines how the issuer and sponsor split the fees for a transaction in which both are participating. Further, the joint venture takes a typically smaller charge per transaction from issuers and sponsors for use of the system. All of these costs are ultimately born on participating merchants that typically must offer up anywhere from 3-7% of the transaction value for enabling the transaction.

Such transaction information is typically maintained by the owners of either closed or open loop systems. The transaction information also is passed to credit rating companies that track usage of individuals.

Furthermore, many cryptographic techniques exist to secure digital information. Conventionally, encoding and decoding methods are employed to render information either securely unreadable (i.e., encoded or encrypted) and conversely readable (i.e., decoded or decrypted). Typically, encryption methods such as the data encryption standard (DES) and or pretty good privacy (PGP) allow for the scrambling of information into a form that is unreadable to anyone not in possession of a proper means of for decryption. Many conventional cryptographic methods employ codes that are used to both encode and decode information. Such codes are conventionally called keys.

### SUMMARY

As set forth below, a need exists for an improved apparatus, system, and method for an electronic payment system. The present system uniquely blends properties of both open and closed loop payment systems. Furthermore, the present system provides a unique way to reduce the transaction cost burden placed upon merchants employing a payment system with the provision of advertisements. Furthermore, the present system provides a way to track the transactional usage of those engaged in transactions and the like without exposing identifying information.

Also, the present system is an apparatus, comprising a memory having at least one region for storing executable program code, and a processor for executing the program code stored in the memory. The program code, further comprises code to affect provision of a credit request, code to affect provision of accesser determined information, code to affect provision of bids for accesser credit requests, and code to affect obtaining preferred credit offers.

Also, the present system is an apparatus, comprising a memory having at least one region for storing executable program code, and a processor for executing the program code stored in the memory. The program code, further comprises code to affect a credit transaction, and, code to affect ad compensation.

Also, the present system is an apparatus, comprising a memory having at least one region for storing executable program code, and a processor for executing the program code stored in the memory. The program code, further comprises code to affect delivery verification payment.

Also, the present system is an apparatus, comprising a memory having at least one region for storing executable program code, and a processor for executing the program code stored in the memory. The program code, further comprises code to affect advertising targeting.

Also, the present system is an apparatus, comprising a memory having at least one region for storing executable program code, and a processor for executing the program code stored in the memory. The program code, further comprises code to affect provision of ads, and code to store ads in a database.

Also, the present system is an apparatus, comprising a memory having at least one region for storing executable program code, and a processor for executing the program code stored in the memory. The program code, further comprises code to affect provision of accesser availability information, and code to store accesser availability information in a database.

Also, the present system is an apparatus, comprising a memory having at least one region for storing executable program code, and a processor for executing the program code stored in the memory. The program code, further comprises code to affect provision of anonID information.

Also, the present system is an apparatus, comprising a memory having at least one region for storing executable program code, and a processor for executing the program code stored in the memory. The program code, further comprises code to affect the limitation of accesser identifying information.

Also, the present system is an apparatus, comprising a memory having at least one region for storing executable program code, and a processor for executing the program code stored in the memory. The program code, further comprises code to affect provision of accesser information, code to affect obtaining accesser information, code to affect provision of accesser credit rating, and code to affect accesser credit rating.

Also, the present system is an apparatus, comprising a memory having at least one region for storing executable program code, and a processor for executing the program code stored in the memory. The program code, further comprises code to affect provision of credit requests, code to affect provision of accesser credit rating, and code to affect provision of accesser credit issuance.

Also, the present system is an apparatus, comprising a memory having at least one region for storing executable program code, and a processor for executing the program code stored in the memory. The program code, further comprises code to affect provision of accesser credit rating.

Also, the present system is an apparatus, comprising a memory having at least one region for storing executable program code, and a processor for executing the program code stored in the memory. The program code, further comprises code to affect provision of accesser anonID information.

Also, the present system is an apparatus comprising a processor, storage, and a program stored in storage. The program comprises a module to inspect an ID, a module to obtain a 3^{rd} party ID code from the ID, a module to identify an ID type from the ID, a module to verify the fidelity of the ID, a module to encrypt the 3^{rd} party ID code into a non repudiation ID, and a module to verify the non repudiation ID is valid.

Also, the present system is an apparatus comprising a processor, storage, and a program stored in storage. The program comprises a module to provide a target system with a dynamic adapter installer medium and affecting installer execution, a module to obtain a desired bridge system type, a module to select payment system bridge software compatible with the desired bridge system, a module to select payment system bridge compatible with the target system from the selected payment system bridge software compatible with the desired bridge system, and a module to install selected and corresponding payment system bridge software compatible with both the target system and the desired bridge system.

The above advantages and features are of representative embodiments only, and are not exhaustive or exclusive. They are presented only to assist in understanding the invention. It should be understood that they are not representative of all the inventions defined by the claims, to be considered limitations on the invention as defined by the claims, or limitations on equivalents to the claims. For instance, some of these advantages may be mutually contradictory, in that they cannot be simultaneously present in a single embodiment. Similarly, some advantages are applicable to one aspect of the invention, and inapplicable to others. Furthermore, certain aspects of the claimed invention have not been discussed herein. However, no inference should be drawn regarding those discussed herein relative to those not discussed herein other than for purposes of space and reducing repetition. Thus, this summary of features and advantages should not be considered dispositive in determining equivalence. Additional features and advantages of the contrivance will become apparent in the following description, from the drawings, and from the claims.

### BRIEF DESCRIPTION OF THE DRAWINGS

The accompanying drawings illustrate certain embodiments of the invention.

FIG. 1 illustrates a centralized controller according to one embodiment of the present contrivance;

FIG. 2 illustrates another embodiment of the present contrivance in the form of a distributed system interacting through a communications network;

FIG. 3 illustrates another embodiment of the system and various user system interactions;

FIG. 4 illustrates web pages, hypertext, reference and proximal links;

FIG. 5 illustrates web forms;

FIG. 6 is a flowchart illustrating another embodiment of the system and of various payment system interactions;

FIG. 7 is a flowchart illustrating another embodiment of the system and of a credit transaction, provision(s), ad compensation, and delivery verification payment;

FIG. 8 is a flowchart illustrating another embodiment of the system and of advertising system interactions;

FIG. 9 is a flowchart illustrating another embodiment of the system and of an advertising targeting system;

FIG. 10 is a flowchart illustrating another embodiment of the system and of an ad and target provision system;

FIG. 11 is a flowchart illustrating another embodiment of the system and of anonyfier interactions;

FIG. 12 is a flowchart illustrating another embodiment of the system and of an anonyfication system;

FIG. 13 is a flowchart illustrating another embodiment of the system and of a credit effect systemization;

FIG. 14 is a flowchart illustrating another embodiment of the system and of a credit auction;

FIG. 15 is a flowchart illustrating another embodiment of the system and of credit provision;

FIG. 16 is a flowchart illustrating another embodiment of the system and of instance profile provision and profile adaptive behavior;

FIG. 17 is a flowchart illustrating another embodiment of the system and of various server systems interactions;

FIG. 18 illustrates anonID web forms;

FIG. 19 illustrates an overview of an embodiment of an identification key to non-repudiation converter;

FIG. 20 further illustrates an overview of an embodiment of an identification key to non-repudiation converter;

FIG. 21 illustrates an overview of one embodiment of a closed loop payment system extra-loop resources enablement system;

FIG. 22 FIG. 22 illustrates an overview of one embodiment of a dynamic adapter;

FIG. 23 illustrates an overview of an embodiment of payment system interaction(s).

### DETAILED DESCRIPTION

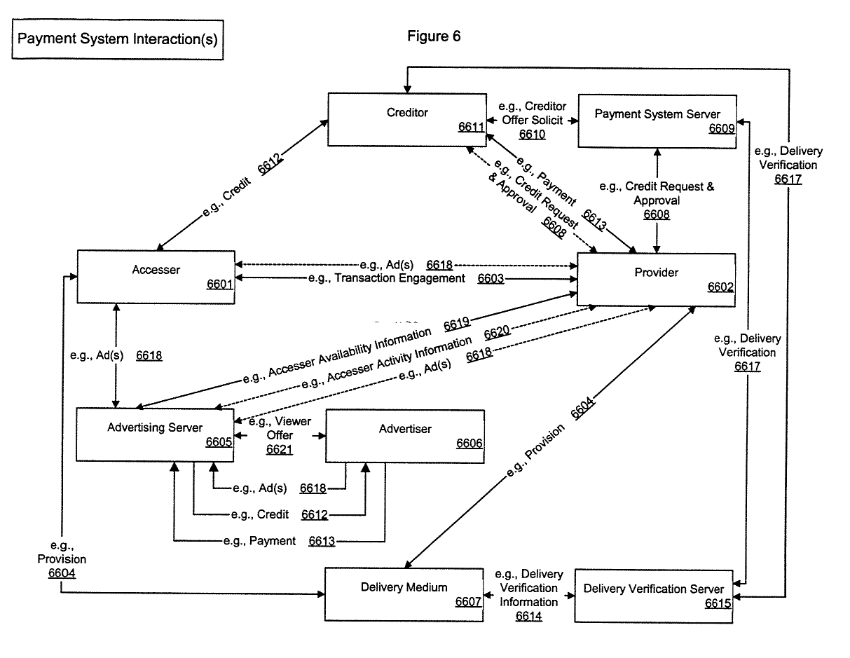

The present contrivance involves various actors and or resources. Generally, the actors take on two forms: accesser(s) 6601 of FIG. 6 and provider(s) 6602 of FIG. 6. An accesser is typically a user that affects the access of a resource(s). A provider is typically an entity that affects the provision of a provision; e.g., creditor(s) 6604 of FIG. 6 providing credit, advertiser(s) 6606 of FIG. 6 providing ad(s), sellers providing goods and or services, and or the like.

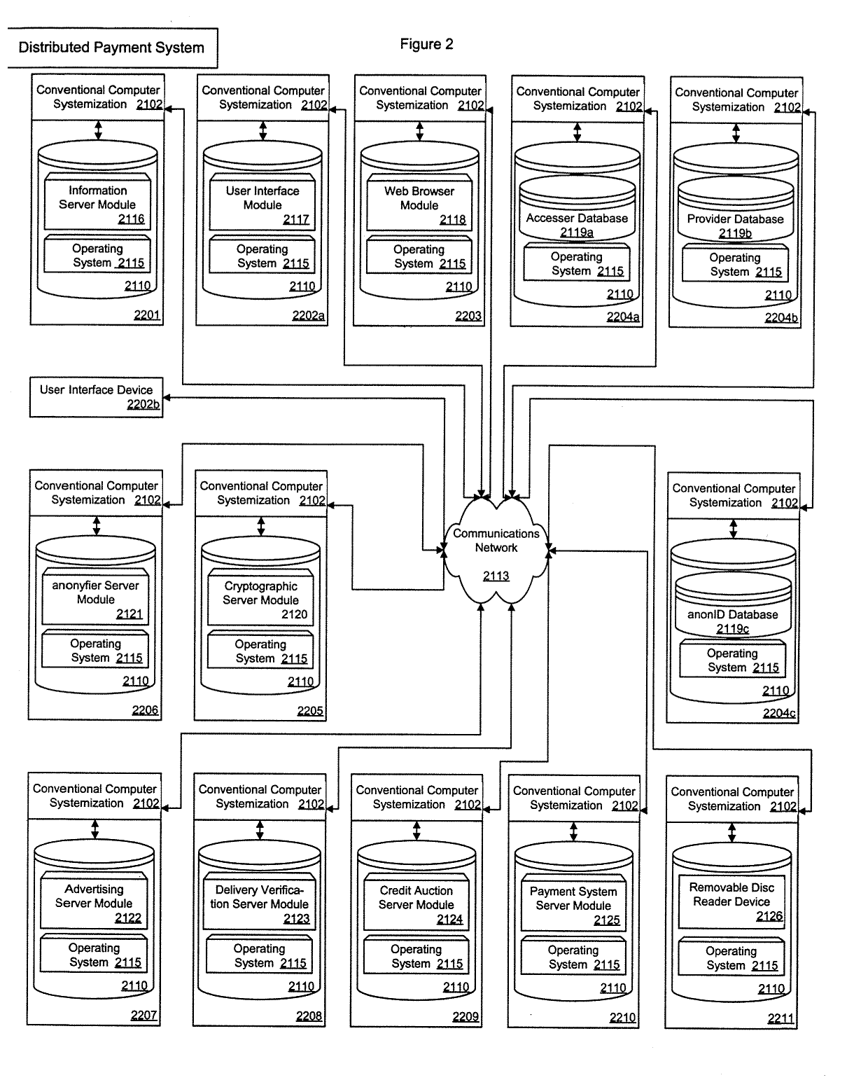

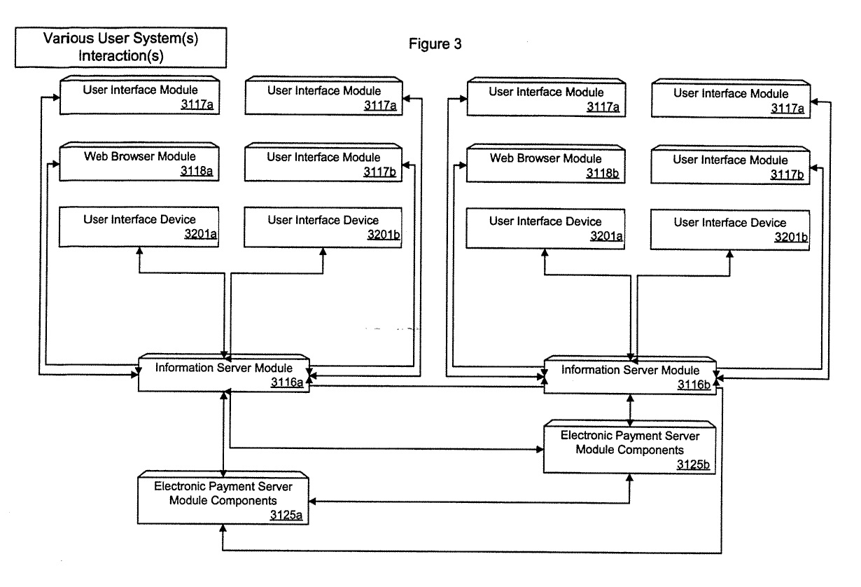

A typical resource is an information server controller 2201 of FIG. 2. An information server module 2116 of FIG. 2, 3317 of FIG. 3 is executed on an information server controller. An information server typically allows provider(s) to affect the provision of resource(s) to accesser(s).

Centralized Controller

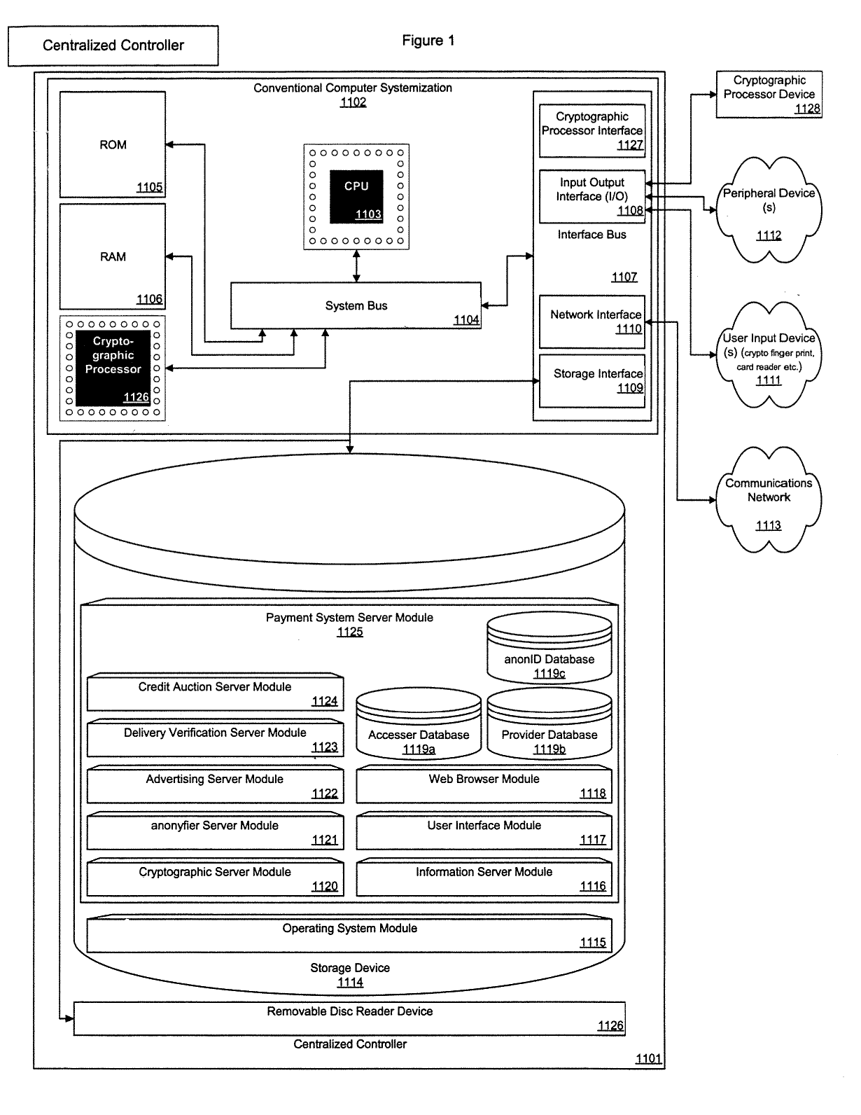

FIG. 1 illustrates one embodiment of a system incorporating the present contrivance.

In this embodiment, the system includes a centralized controller 1101, which may be connected to and or communicate with entities such as, but not limited to: one or more users from user input device(s) 1111, e.g., receive input; peripheral device(s) 1112; and or a communications network 1113. The centralized controller may even be connected to and or communicate with a cryptographic processor device 1128.

A typical centralized controller 1101 may be based on common computer systems that may comprise, but are not limited to, components such as: a conventional computer systemization 1102 connected to a storage device(s) 1114, and or optionally a removable disc reader device 1126. The storage device(s) may be a fixed hard disk drive, and or other device(s) of the like. The removable disc reader device may be a compact disc read only memory device (CD ROM), floppy diskette drive, and or other device(s) of the like.

Conventional computer systemization(s) 1102 may comprise a central processing unit (CPU) 1103, a read only memory (ROM), a random access memory (RAM), and or an interface bus 1107, and conventionally although not necessarily, are all interconnected and or communicating through a system bus 1104. Optionally, a cryptographic processor 1126 may similarly be connected to the system bus. Of course, any of the above components may be connected directly to one another, connected to the CPU, and or organized in numerous variations employed as exemplified by conventional computer systems.

The CPU comprises at least one high-speed data processor adequate to execute program modules for executing user and or system-generated requests. Preferably, the CPU is a conventional microprocessor such as the Intel Pentium Processor and or the like. The CPU interacts with RAM, ROM, and storage device(s) to execute stored program code according to conventional data processing techniques.

Interface bus(ses) 1107 may accept, connect, and or communicate to a number of interface adapters, conventionally although not necessarily in the form of adapter cards, such as but not limited to: input output interface(s) (I/O) 1108, storage interface(s) 1109, network interface(s) 1110, and or the like. Optionally, cryptographic processor interface(s) 1127 may similarly be connected to the interface bus. The interface bus provides for the communication(s) of interface adapter(s) with one another as well as with other component(s) of the conventional computer systemization. Interface adapters are adapted for a compatible interface bus. Interface adapters conventionally connect to the interface bus via a slot architecture. Conventional slot architectures may be employed, such as, but not limited to: AGP, Card Bus, ISA, EISA, MCA, NuBus, PCI, PCMCIA, and or the like.

Storage interface(s) 1109 may accept, communicate, and or connect to a number of storage device(s) such as, but not limited to: storage device(s), removable disc reader device(s), and or the like. Storage interfaces may employ connection protocol(s) such as, but not limited to: (E)IDE, IEEE 1394, Fibre Channel, SCSI, USB, and or the like.

Network interface(s) 1110 may accept, communicate, and or connect to a communications network 1113. Network interface(s) may employ connection protocol(s) such as, but not limited to: direct connect, Ethernet (thick, thin, twisted pair 10/100/1000 Base T, and or the like), Token Ring, wireless connection, and or the like. A communications network may be: the Internet; a local area network (LAN); a wide area network (WAN); a wireless network (e.g., employing protocols such as, but not limited to a wireless application protocol (WAP)); a secured custom connection; and or the like.

Input output interface(s) (I/O) 1108 may accept, communicate, and or connect to user input device(s) 1111, peripheral device(s) 1112, cryptographic processor device(s) 1128, and or the like. I/O may employ connection protocol(s) such as, but not limited to: ADB; audio: analog, digital, monaural, RCA, stereo, and or the like; infrared; joystick; keyboard; midi; optical; PC AT; PS/2; parallel; radio; serial; video: BNC, composite, digital, RCA, S-Video, VGA, and or the like; wireless; and or the like.

User input device(s) 1111 may be card reader(s), dongle(s), finger print reader(s), glove(s), graphics pad(s), joystick(s), keyboard(s), mouse (mice), trackball(s), trackpad(s), retina reader(s), and or the like.

Peripheral device(s) 1112 may be connected and or communicate with or to I/O and or with or to other facilities of the like (e.g., network interface(s), storage interfaces, and or the like). Peripheral device(s) may be camera(s), dongle(s) (e.g., for copy protection, ensuring secure transactions as a digital signature, and or the like), external processor(s) (e.g., for added functionality), goggle(s), microphone(s), monitor(s), network interface(s), printer(s), scanner(s), storage device(s), visor(s), and or the like.

Cryptographic unit(s) such as, but not limited to, microcontroller(s), processor(s) 1126, interface(s) 1127, and or device(s) 1128 may be attached, and or communicate with the centralized controller. A MC68HC16 microcontroller, commonly manufactured by Motorola Inc., may be used for and or within cryptographic unit(s). Equivalent microcontrollers and or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner284.

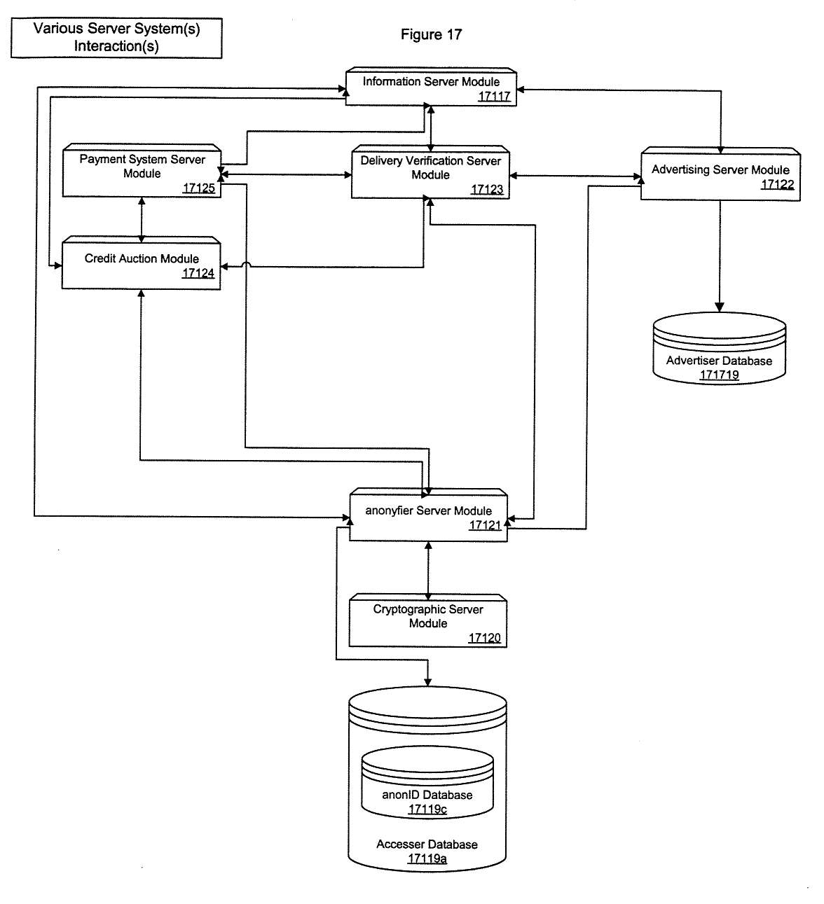

The storage device(s) may contain a collection of program and or database modules such as, but not limited to: an operating system module 1115 (i.e., operating system); an information server module 1116 (i.e., information server); a user interface module 1117 (i.e., user interface); a web browser module 1118 (i.e., web browser); database(s) 1119 such as, but not limited to accesser database(s) 1119a, provider database(s) 1119b, anonID database(s) 1119c, advertiser database(s) 171719 of FIG. 17, and or the like; a cryptographic server module 1120 (i.e., cryptographic server); an anonyfier server module 1121 (i.e., anonyfier); an advertising server module 1122 (i.e., advertising server); a delivery verification server module 1123 (i.e., delivery verification server); a credit auction server module 1124 (i.e., credit auction); payment system server module 1125, and or the like (i.e., a module collection). These modules may be stored and accessed from the storage device(s) and or from storage devices accessible through an interface bus. Although these modules typically and preferably are stored in a local storage device, they may also be stored in peripheral device(s), RAM, remote storage facilities through a communications network, ROM, and or the like.

The operating system 1115 is executable program code facilitating the operation of a centralized controller. The operating system facilitates access of I/O, network interface(s), peripheral device(s), storage device(s), and or the like. The operating system preferably is a conventional product such as a Microsoft Windows NT Server and or Unix operating system(s). Preferably, the operating system is highly fault tolerant, scalable, and secure. An operating system may communicate to and or with other modules in a module collection, including itself, and or facilities of the like. Conventionally, the operating system communicates with other program module(s), user interface(s), and or the like; e.g., it may communicate, generate, obtain, and or provide program module, system, user, and or data communication(s), request(s), and or response(s). The operating system, once executed by the CPU, may interact with communication(s) network(s), data, I/O, peripheral device(s), program module(s), RAM, ROM, storage devices, user input devices, and or the like. Preferably, the operating system provides communication(s) protocol(s) that allow the centralized controller to communicate with other entities through a communications network. The preferred protocol is TCP/IP.

Distributed System Interactions

FIG. 2 illustrates another embodiment of a system incorporating the present contrivance. In this embodiment, the centralized controller 1101 embodiment of FIG. 1 has been decentralized into components such as, but not limited to: a information server controller 2201; user interface controller 2202a and or alternatively a user interface device 2202b; a web browser controller 2203; database controller(s) such as, but not limited to accesser database controller(s) 2204a, provider database controller(s) 2204b, anonID database controller(s), advertising database controllers (not pictured, but could similarly be provided employing advertising database(s) 171719 of FIG. 17), and or the like; a cryptographic controller 2205; an anonyfier controller 2206; an advertising controller 2207; a delivery verification controller 2208; a credit auction controller 2209; a payment system controller 2210; a removable disc reader device controller; and or the like (i.e., decentralized server controllers). The aforementioned controllers of FIG. 2 may be attached, interconnected, and or communicate through a communications network 2113 and or like facility.

An information server controller 2201 is comprised similarly to the centralized controller of FIG. 1 except it does not require an entire module collection other than an information server module, nor does it require a removable disc reader device. An information server module 2116 is stored program code that is executed by the CPU. Preferably, the information server is a conventional Internet information server such as Microsoft's Internet Information Server revision 4.0. Preferably, the information server allows for the execution of program modules through facilities such as C++, Java, JavaScript, ActiveX, CGI scripts, ASP, any facility with regular expression (regex) abilities (on the server side), and or the like. Conventionally, an information server provides results in the form of web pages to web browsers, and allows for the manipulated generation of the web pages through interaction with other program modules. An information server may communicate to and or with other modules in a module collection, including itself, and or facilities of the like. Most frequently, the information server communicates with operating system(s), other program module(s), user interface(s), web browser(s), and or the like; e.g., it may communicate, generate, obtain, and or provide program module, system, user, and or data communication(s), request(s), and or response(s).

A user interface controller 2202a is comprised similarly to the centralized controller of FIG. 1 except it does not require an entire module collection other than an user interface module 2117, nor does it require a removable disc reader device. A user interface is stored program code that is executed by the CPU. Preferably, the user interface is a conventional user interface as provided by, with, and or atop operating systems and or operating environments such as Apple Macintosh OS, Microsoft Windows (NT), Unix X Windows (KDE, Gnome, and or the like), and or the like. Preferably, the user interface allows for the execution, interaction, manipulation, and or operation of program modules and or system facilities through graphical facilities. The user interface provides a facility through which users may affect, interact, and or operate a computer system. An user interface may communicate to and or with other modules in a module collection, including itself, and or facilities of the like. Most frequently, the user interface communicates with operating system(s), other program module(s), and or the like; e.g., it may communicate, generate, obtain, and or provide program module, system, user, and or data communication(s), request(s), and or response(s).

In alternative embodiments, a user interface device 2202 may take the place of and or be used in conjunction with a user interface controller. The user interface device may be a consumer electronics online access device (e.g., Phillips Inc.'s WebTV), PDA, telephone, and or the like.

A web browser controller 2203 is comprised similarly to the centralized controller of FIG. 1 except it does not require an entire module collection other than web browser module 2118, nor does it require a removable disc reader device. A web browser is stored program code that is executed by the CPU. Preferably, the web browser is a conventional hypertext viewing application such as Microsoft Internet Explorer or Netscape Navigator. Preferably, the web browser allows for the execution of program modules through facilities such as Java, JavaScript (preferably revision 1.2 or greater), ActiveX, any facility with regular expression (regex) abilities, and or the like. A web browser may communicate to and or with other modules in a module collection, including itself, and or facilities of the like. Most frequently, the web browser communicates with information server(s), operating system(s), integrated program module(s) (e.g., plug-ins), and or the like; e.g., it may communicate, generate, obtain, and or provide program module, system, user, and or data communication(s), request(s), and or response(s).

A database controller 2204 is comprised similarly to the centralized controller of FIG. 1 except it does not require an entire module collection other than database module(s) 2119, nor does it require a removable disc reader device. A database is stored program code that is executed by the CPU and it is stored data processed by the CPU. Preferably, the database is a conventional, fault tolerant, relational, scalable, secure database such as Oracle or Sybase. A database may communicate to and or with other modules in a module collection, including itself, and or facilities of the like. Most frequently, the database communicates with information server(s), operating system(s), other program module(s), and or the like; e.g., it may communicate, generate, obtain, and or provide program module, system, user, and or data communication(s), request(s), and or response(s).

Databases may be consolidated and or distributed in countless variations through standard data processing techniques. Portions of database(s), e.g., tables, may be exported and or imported and thus decentralized and or integrated. An accesser database controller 2204a is a specialized controller designed to facilitate accesser related transactions. The accesser database controller employs an accesser database module 2119a. Of course, employing standard data processing techniques, one may further distribute the accesser database over several conventional computer systemizations and or storage devices. Similarly, configurations of a provider database controller 2204b, and or a anonID database controller 2204c may be varied by consolidating and or distributing a provider database module 2119b and or anonID database module 2119c. A provider database facilitates provider related transactions. Another variant of a provider database is an advertising database module 171719 of FIG. 17. An anonID database facilitates anonymous transactions.

A cryptographic sever controller 2205 is comprised similarly to the centralized controller of FIG. 1 except it does not require an entire module collection other than cryptographic server module 2120, nor does it require a removable disc reader device. A cryptographic server module is stored program code that is executed by the CPU 1103 of FIG. 1, cryptographic processor 1126 of FIG. 1, cryptographic processor interface 1127 of FIG. 1, cryptographic processor device 1128 of FIG. 1, and or the like. Preferably, cryptographic processor interface(s) will allow for expedition of encryption and or decryption requests by the cryptographic server, however, the cryptographic server may run on a conventional CPU. Preferably, the cryptographic server allows for the encryption and or decryption of provided data. Preferably, the cryptographic server allows for both symmetric and asymmetric (e.g., Pretty Good Protection (PGP)) encryption and or decryption. Preferably, the cryptographic server allows conventional cryptographic techniques such as, but not limited to: digital certificates (e.g., X.509 authentication framework), digital signatures, dual signatures, enveloping, public key management, and or the like. Preferably, the cryptographic server will employ numerous encryption and or decryption protocols such as, but not limited to: Data Encryption Standard (DES), Elliptical Curve Encryption (ECC), International Data Encryption Algorithm (IDEA), MD5, RC5 (Rivest Cipher), RSA (Rivest, Shamir, and Adleman) Secure Hash Algorithm (SHA), and or the like. A cryptographic server may communicate to and or with other modules in a module collection, including itself, and or facilities of the like. Most frequently, the cryptographic server communicates with anonyfier server module(s), information server(s), operating system(s), other program module(s), and or the like; e.g., it may communicate, generate, obtain, and or provide program module, system, user, and or data communication(s), request(s), and or response(s).

A anonyfier server controller 2206 is comprised similarly to the centralized controller of FIG. 1 except it does not require an entire module collection other than anonyfier server module(s) 2121, nor does it require a removable disc reader device. An anonyfier server module is stored program code that is executed by the CPU. The anonyfier server masks the identity from accesser(s)' accesses and or transaction(s) with an information server and or computer system while maintaining transaction data. Preferably the anonyfier employs a cryptographic server to encrypt and decrypt accesser identity. The anonyfier server may store anonyfied information in an anonID database 2119c. An anonyfier may communicate to and or with other modules in a module collection, including itself, and or facilities of the like. Most frequently, the anonyfier communicates with cryptographic server(s), database(s), information server(s), operating system(s), other program module(s), and or the like; e.g., it may communicate, generate, obtain, and or provide program module, system, user, and or data communication(s), request(s), and or response(s).

A advertising server controller 2207 is comprised similarly to the centralized controller of FIG. 1 except it does not require an entire module collection other than advertising server module(s) 2122, nor does it require a removable disc reader device. An advertising server module is stored program code that is executed by the CPU. The advertising server affects obtaining and the provision of ads from advertiser(s) to accesser(s). Preferably, although not necessarily, the advertising server employs the services of an anonyfier for targeting accesser(s) without revealing identity. An advertising server may communicate to and or with other modules in a module collection, including itself, and or facilities of the like. Most frequently, the advertising server communicates with anonyfier(s), database(s), information server(s), operating system(s), other program module(s), and or the like; e.g., it may communicate, generate, obtain, and or provide program module, system, user, and or data communication(s), request(s), and or response(s).

A delivery verification server controller 2208 is comprised similarly to the centralized controller of FIG. 1 except it does not require an entire module collection other than delivery verification server module(s) 2123, nor does it require a removable disc reader device. A delivery verification server module is stored program code that is executed by the CPU. The delivery verification server affects obtaining and the provision of provision(s) delivery, typically although not necessarily, for payment system(s). A delivery verification server may communicate to and or with other modules in a module collection, including itself, and or facilities of the like. Most frequently, the delivery verification server communicates with anonyfier(s), database(s), information server(s), operating system(s), payment system server(s), other program module(s), and or the like; e.g., it may communicate, generate, obtain, and or provide program module, system, user, and or data communication(s), request(s), and or response(s).

A credit auction server controller 2209 is comprised similarly to the centralized controller of FIG. 1 except it does not require an entire module collection other than credit auction server module(s) 2124, nor does it require a removable disc reader device. A credit auction server module is stored program code that is executed by the CPU. The credit auction affects obtaining and the provision of credit, typically although not necessarily, from creditors through payment system(s) for accesser(s). A credit auction may communicate to and or with other modules in a module collection, including itself, and or facilities of the like. Most frequently, the credit auction server communicates with anonyfier(s), database(s), information server(s), operating system(s), payment system server(s), other program module(s), and or the like; e.g., it may communicate, generate, obtain, and or provide program module, system, user, and or data communication(s), request(s), and or response(s).

A payment system server controller 2210 is comprised similarly to the centralized controller of FIG. 1 except it does not require an entire module collection other than payment server module(s) 2125, nor does it require a removable disc reader device. A payment system server module is stored program code that is executed by the CPU. The payment system server affects obtaining and the provision of payment and or credit, typically although not necessarily, from creditors through payment system(s) for accesser(s). A payment system server may communicate to and or with other modules in a module collection, including itself, and or facilities of the like. Most frequently, the payment system server communicates with database(s), information server(s), operating system(s), other program module(s), and or the like; e.g., it may communicate, generate, obtain, and or provide program module, system, user, and or data communication(s), request(s), and or response(s).

A removable disc reader device controller 2211 is comprised similarly to the centralized controller of FIG. 1 except it does not require an entire module collection. A removable disc reader device controller allows for the provision of removable media. More particularly for security purposes, it allows for the provision of security cards to be read; e.g., Digicard. Specially adapted security cards may be placed into specially adapted removable media for reading by the disc reader device controller. Such a facility can provide heightened security for transactions over a communications network and or otherwise.

The functionality of any of the distributed server controller(s) may be combined, consolidated, and or distributed in any number of ways to facilitate development and or deployment. To accomplish recombining the functionality of the distributed server controller(s), one may simply copy the executable program module code from the module collection and or with other program modules, first ensuring the executable program module code has been compiled for the appropriate CPU of the controller for which it is destined, and or data onto a local storage device of any of the various controllers. Similarly, the module collection may be combined in any number of ways to facilitate deployment and or development. To accomplish this, one must simply integrate the components into a common code base or in a facility that can dynamically load the components on demand in an integrated fashion.

The module collection may be consolidated and or distributed in countless variations through standard data processing techniques. Multiple instances of any one of the program modules in the program module collection may be instantiated on a single controller, and or across numerous controllers to improve performance through standard load balancing data processing techniques. Furthermore, single instances may also be distributed across multiple controllers and or storage devices; e.g., database(s).

All program module instances and controllers work in concert through standard data processing communication techniques.

The preferable centralized and or distributed controller configuration will depend on the context of system deployment; i.e., factors such as, but not limited to, the capacity and or location of the underlying hardware resources. Regardless of if the configuration results in more consolidated integrated program module(s), results in a more distributed series of program modules, and or results in some combination between a consolidated and or distributed configuration, communication of data may be communicated, obtained, and or provided. Instances of modules (from the module collection) consolidated into a common code base from the program module collection may communicate, obtain, and or provide data. This may be accomplished through standard data processing techniques such as, but not limited to: variable passing, object instance variable communication, internal messaging, shared memory space, and or the like.

If module collection components are discrete, separate, and or external to one another, communicating, obtaining, and or providing data with and or to other module components may be accomplished through standard data processing techniques such as, but not limited to: shared file(s), process pipe(s), application program interface(s) (API) information passage (i.e., inter application communication), and or the like. Again, the preferable embodiment will depend upon the context of system deployment.

Various User System Interactions

FIG. 3 illustrates an overview of various user system(s) interaction(s). Information server(s) 3116 act as an in-between for electronic payment server module components 3125 and: user interface(s) 3117, user interface device(s) 3201, web browser(s) 3118, and or the like. Generally, the information server(s) take requests. The information server can make further requests of electronic payment server component(s) 3125. Electronic payment server components comprise modules from the module collection and or the like, except it does not include a web browser module, user interface module, or information server module. Both the information server and electronic payment server components may service multiple instances of any of the user interface(s), user interface device(s), and or web browsers; i.e., user interface component(s). However, it is preferable for the information server to act as a proxy for electronic payment server component(s) rather than them directly interfacing with user interface component(s). Also, there may be one or more instances of the information server and or electronic payment server component(s) that may severally or jointly interact with one another.

Generally, electronic payment server components service information server(s), which in turn service user interface components. FIG. 3 illustrates that components may be numerously instantiated and may service multiple and various components. For example a user interface 3117 may make numerous communications. In this example, the user interface 3117a makes two communications with an information server 3116a while also communicating with another information server 3116b; all while another instance of a user interface 3117b also communicates with the other information server 3116b. Similarly in another example, a user interface device 3201 may make numerous communications. In this example, the user interface device 3201a makes two communications, one with an information server 3116a, and a second with another information server 3116b; all while another instance of a user interface device 3201b also makes two communications, also one with an information server 3116a, and a second with the other information server 3116b. Similarly, the web browser 3118a communicates with an information server 3116a while another instance of a web browser 3118b also communicates another instance of the information server 3116b.

Similarly, information server module(s) 3116 and electronic payment server component(s) 3125 may make multiple communications and may be instantiated multiple times. For example electronic payment server component(s) 3125 may make numerous communications. In this example, the electronic payment component(s) 3125a makes three communications with an information server 3116a, another information server 3116b, and with another instance of electronic payment server component(s) 3125b (also, the electronic payment server component(s) 3125a may communicate with itself). Similarly, the electronic payment component(s) 3125b makes three communications with an information server 3116a, another information server 3116b, and with the first instance of electronic payment server component(s) 3125a (also, the electronic payment server component(s) 3125b may communicate with itself).

Web Browsers

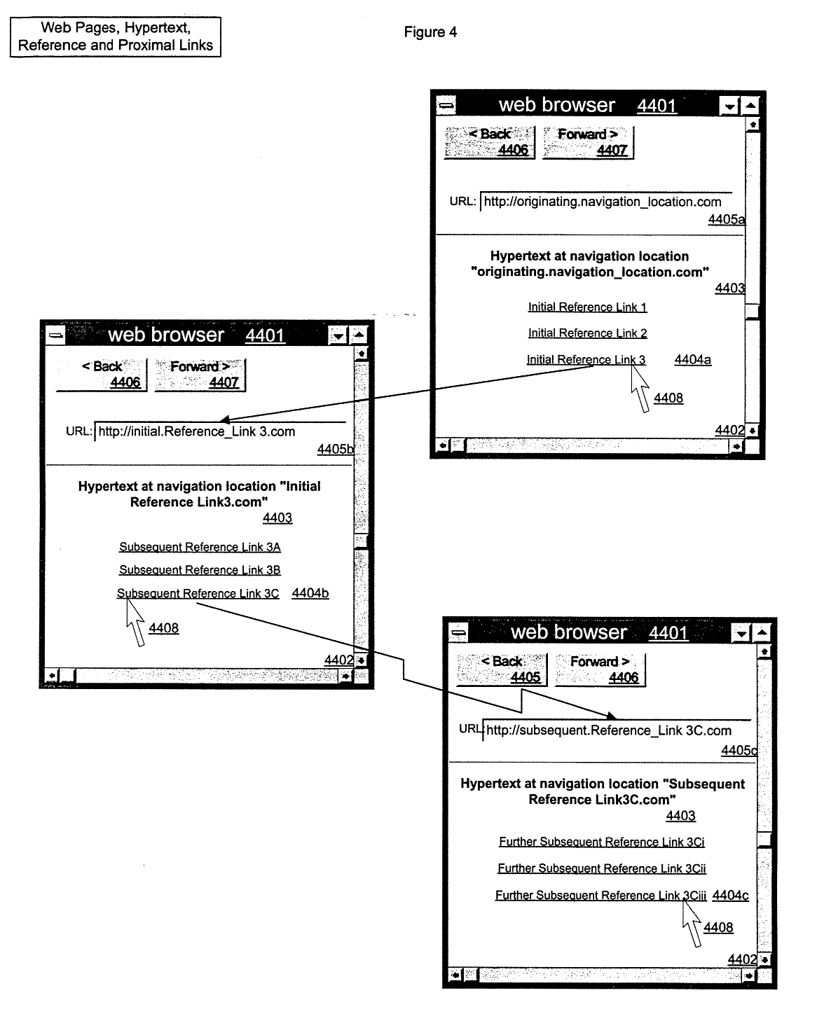

FIG. 4 shows web browsers 4401 containing web pages 4402 with hypertext 4403 and reference links 4404 at various navigation locations 4405. An originating navigation location 4405a references hypertext that may have initial reference links 4404a. These initial reference links are proximal links to the originating navigation location.

One may view hypertext at an initial reference navigation location 4405b by traversing an initial reference link. Conventionally, an accesser achieves link traversal by targeting a graphical pointing element (i.e., a cursor) 4408 on a video display peripheral device (i.e., a screen) atop the reference link within a web browser with a pointing device (i.e., mouse) and making a selection by engaging a button on the mouse. Subsequent reference links 4404b found in the hypertext found at the initial reference navigation location 4405b are also proximal links, however, they are one reference less proximal (i.e., one “hop” away) to the originating navigation location.

One may view hypertext at a subsequent reference navigation location 4405c by traversing a subsequent reference link. The further subsequent reference links 4404c found in the hypertext found at the subsequent reference navigation location 4405c are also proximal links, however, they are two references less proximal (i.e., two “hops” away) to the originating navigation location.

One may also navigate by engaging the forward 4407 and back 4406 buttons conventionally provided by web browsers. After having traversed the aforementioned links to a subsequent reference navigation location 4405c, an accesser may traverse back to an initial reference navigation location 4405b by engaging the back button 4406. After having traversed to the initial reference navigation location 4405b, the accesser may traverse forward to a subsequent reference location by engaging the forward button 4407.

Web Forms

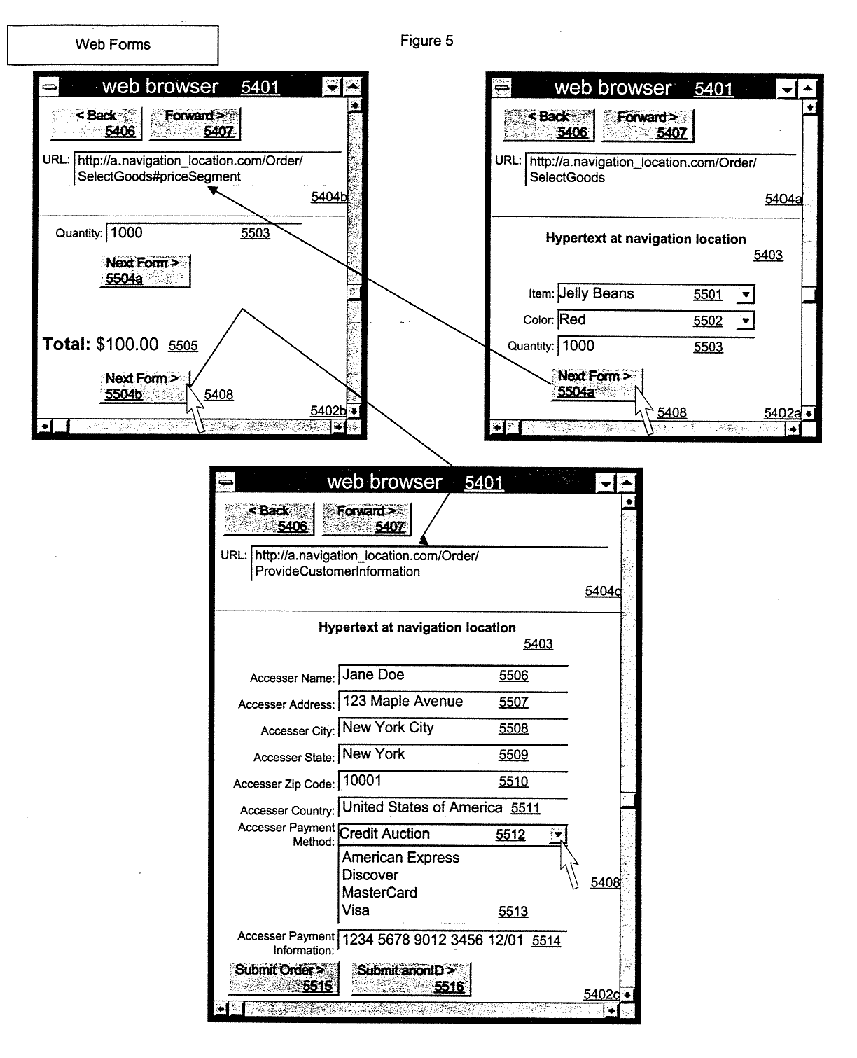

FIG. 5 illustrates web forms. This illustration is for purposes of example only, and in no way should be considered a limited application and or implementation of the present contrivance. Web browsers 5401 display web pages 5402 containing hypertext 5403 and or web form elements such as but not limited to: text fields 5506, 5507, 5508, 5509, 5510, 5511; numerical fields 5503; hybrid (e.g., numerical and date) fields 5514; pop up menus 5501, 5502, 5512; pop up menu selection lists 5513; buttons 5504, 5515; and the like. A web page with web form elements is a web form. A web form segment is a portion of a web form, which may be provided within a single html document at another location in that document (e.g., by using html positioning techniques such as anchors (“#”), or it may be provided by another html document.

A web form is illustrated with an example order for jelly beans 5402, however, web forms may be employed for any number of uses. The accesser may enter information into web fields into a web form segment 5402a at a navigation location allowing for the selection of goods 5404a; e.g., selecting “Jelly Beans” in an item field 5501, selecting “Red” in a color field 5502, and providing a quantity “1000” in a quantity field 5503, and or the like. After having entered information into each of the web fields, the accesser may advance to the next web form segment by engaging a button 5504a or other facility of the like designed to advance the web browser to another web form segment by employing standard data processing techniques. Of course, innumerable web forms may be provided to an accesser by provider(s) with all kinds of field types specific to a transaction. Furthermore, providers may provide pricing information and many other types of information to an accesser before advancing to an accesser to the next web form segment 5402b at another navigation location 5404b. This web form segment contains updated price information 5505 with regard to the illustrated jelly bean purchase. The accesser may then continue to the next form segment at another navigation location 5404c by engaging a next form button 5504b or like facility.

In this web form segment, the accesser may enter information into web fields into a web form segment 5402c at a navigation location allowing for the selection of goods 5404c; e.g., providing an accesser name “Jane Doe” into an accesser name field 5506, providing an accesser address “123 Maple Avenue” into an accesser address field 5507, providing an accesser city “New York City” into an accesser city field 5508, providing an accesser state “New York” into an accesser state field 5509, providing an accesser zip code “10001” into an accesser zip code field 5510, providing an accesser country “United States of America” into an accesser country field 5511, selecting “Credit Auction” in payment method field 5512 from a popup menu 5512 from a pop up list 5513, providing an accesser payment information “1234 5678 9012 3456 12/01” into an accesser payment information field 5514, and or the like. Of course, an accesser may edit information provided in the web form employing standard web form editing techniques.

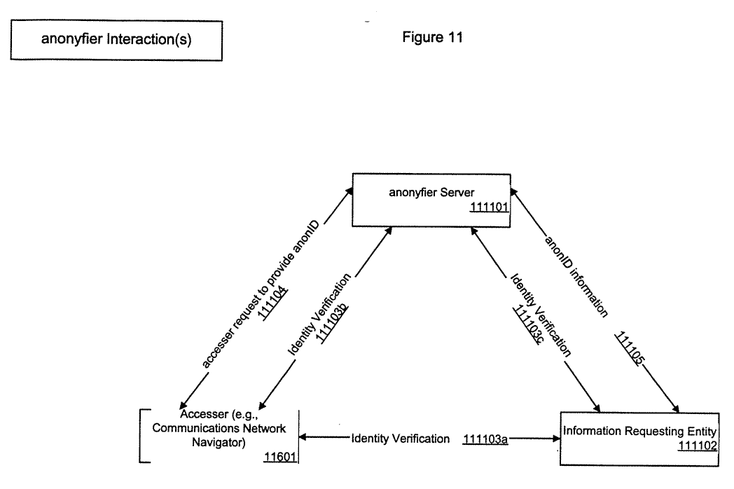

Typically, upon completing an order, the accesser may engage a submit order button 5515, which typically provides the relevant contents of the web form to a provider for processing. Typically thereafter, an accesser will obtain an approval, denial, confirmation of their order, and or the like. However, in alternative embodiments, upon the completing an order and or in lieu of providing information in the customer information web form segment 5402c, an accesser may submit anonID information (anonID information discussed in FIGS. 11, 12, and 18) by engaging a submit anonID button 5516, and or like facility enabling the provision of anonID information.

Forward 5407 and back 5406 buttons work similarly as described in FIG. 4 4407, 4406.

Various Payment System Interactions

FIG. 6 illustrates various payment system interaction(s). Typically an accesser 6601 wishing to engage a provider 6602 in a transaction engagement 6603 in some way accesses a provider and or provider facility. In the realm of electronic commerce (i.e., E-Commerce), a provider may provide an information server to facilitate such an exchange with an accesser employing a web browser, but in the world of brick and mortar a storefront may be provided to facilitate such an exchange with an accesser employing a pair of Nikes. In other words, there are innumerable ways for a transaction engagement to occur between an accesser and provider. Generally, a transaction engagement commences upon an accesser and provider coming to preliminary terms whereby there may be provision of provision(s) by the provider to the accesser. Commonly, although not necessarily, the provision of provision(s) by the provider is in exchange for monetary consideration. A transaction becomes complete upon the accesser necessarily obtaining requested provision(s) and, optionally, although typically, if it is a requirement of the provision, upon the provider obtaining an agreed upon monetary consideration.

In the realm of E-commerce, a transaction engagement typically, although not necessarily, may commence as described in the example of FIG. 5. Typically after transaction engagement commencement, a provision 6604 is provided to a delivery medium 6607 by the provider. A provision may be good(s), service(s), information, and or the like. A delivery medium obtains provision(s) and affects the provision of provision(s) to the accesser. Conventionally for goods, a delivery medium may be courier services, postal services, and or the like. Conventionally for services, a delivery medium may be provider associate(s) engaged in the provision of requested services, and or the like. Conventionally for information, a delivery medium may be a communications network, and or the like. The delivery of provisions may occur in a serial and or concurrent fashion with regard to the provision and obtaining of credit 6612 and or payment 6613.

Upon transaction engagement commencement, a provider may make a credit and or approval request 6608 to charge an accesser by engaging a payment system server 6609. A payment system server may be a device, entity, and or the like. Payment system servers vary in abilities and or attributes depending upon the implementation; factors affecting implementation such as, but not limited to entity backing, providing, subsidizing, supporting its operation(s) and or others of the like may affect ability and attributes of a payment system. Some conventional payment system server abilities are: pre-approval for specified monetary amounts for an accesser without issuing credit, available credit for an accesser, credit rating of an accesser, obtaining and or providing credit for an accesser, obtaining and or providing approval for credit for an accesser, and or the like. A payment system server may be under the control of a creditor, bank, financial institution, and or the like.

The payment system server may provide a creditor with an offer to provide credit to an accesser, and or solicit a creditor to provide an offer for credit for an accesser 6610. The payment system server may provide the creditor with the accesser's credit rating and financial background. Upon the creditor's obtaining a credit offer and or solicitation for offers, the creditor may approve the provision of credit and either provides that approval directly to the provider, and or to the payment system server, which in turn may provide approval information to the provider. Typically, upon the provider's obtaining an approval code for the accesser transaction, the provider will provide requested provisions 6604 to a delivery medium 6607 for delivery. Upon approval, transaction engagement concludes.

Upon the approval of credit for the accesser, either the payment system server and or the creditor may provide credit 6612 to the accesser. The accesser will owe the creditor a debt for facilitating the transaction. Typically the creditor and or the payment system server may issue invoices to the accesser for the debt and the accesser may either provide the creditor with the required monetary compensation either directly, and or through a payment system server, which in turn would provide the creditor with the monetary compensation. Typically, the creditor would also provide the provider with payment on behalf of the accesser facilitating the transaction. This payment conventionally occurs at some predetermined interval, typically thirty days. The provider may obtain this payment from the creditor via the payment system server.

Upon the transaction engagement conclusion, either a provider and or preferably an advertising server 6605 may provide ad(s) 6618 to the accesser. Typically, upon transaction engagement conclusion the provider will provide an advertising server 6605 with accesser availability information 6619 and or accesser activity information 6620. The accesser activity and availability information may be obtained using conventional computer web tracking techniques. Upon the advertising server obtaining accesser availability and or activity information from the provider, the advertising server will obtain a number of ad(s) targeted for the accesser. Typically, these ad(s) will be stored on an advertiser database 171719 of FIG. 17. Preferably, upon obtaining a determined number of ad(s) for the accesser, the advertising server will provide the ad(s) directly to the accesser. However, the advertising server may provide the ad(s) to the provider and or any other entities wishing to use its targeting services for further provision to an accesser and or other entities of the like. Thus, upon transaction engagement commencement, the accesser will be provided with, typically, a web page of targeted ad(s) for viewing and or further navigation, traversal, and or the like.

Advertiser(s) 6606 may provide ad(s) to an advertising server for dissemination. The entity controlling the advertising sever maybe analogized to a provider. Further, the advertiser in this context may be analogized to an accesser. Typically, advertisers will pay to have their ad(s) 6618 disseminated by the advertising server. Viewer offer(s) 6621 and or solicitations to receive offer(s) may be made by either advertiser(s) and or the advertising server to one another. Viewer offer(s) represent accesser(s) either currently available, and or subsequently available for obtaining ad(s) dissemination. Advertising server(s) may provide advertiser(s) with viewer offer(s) and or solicit advertiser(s) for viewer offers. Viewer offer(s) may be made in batch prior to accesser availability and or on a real time basis. Viewer offer(s) may vary based on factors such as, but not limited to viewer credit rating, provision selection, statistical profiling, and or the like. Furthermore, advertiser(s) and advertising server(s) may employ payment systems with which to provide credit 6612 and payment 6613 for the dissemination of ad(s). Typically, advertisers will provide the advertising server with ad(s) 6618 for dissemination. Typically, the advertising server will charge advertisers for this dissemination service.

A delivery medium 6607 may provide delivery verification information 6614 to a delivery verification server 6615. In the case of services, courier services, postal services, and or the like, tracking information may be obtained from the service provider, i.e., delivery medium, via electronic tracking systems, such as, but not limited to: Federal Express web server tracking, UPS web server tracking, United Postal Services web server tracking, and or the like. In the case of information, delivery receipt information may be provided by the accesser's system to the provider and relayed to a creditor and or payment system server; alternatively, copies of the delivery receipt information may be provided directly to creditor(s) and or payment system server(s). Delivery receipt information may be provided employing standard information receipt techniques such as but not limited to: E-mail delivery and or read receipts, header and or traceroutes network verification, digital certificates, and or the like.

A provider may provide a payment system server and or creditor with tracking information provided by the delivery medium with regard to the provider's provision of provisions to the delivery medium. The payment system server and or creditor may then provide the provision tracking information to the delivery verification server.

The payment system server and or creditor may make delivery verification requests 6617 of the delivery verification server and or the delivery verification server may independently seek to obtain delivery verification from the delivery medium after having obtained provision tracking information. Typically the delivery verification server will obtain delivery verification information from the delivery medium and provide delivery verification to either the payment system server and or creditor. Preferably, although not necessarily, upon obtaining delivery verification, the payment system and or creditor may then release payment to the provider.

Credit Transaction

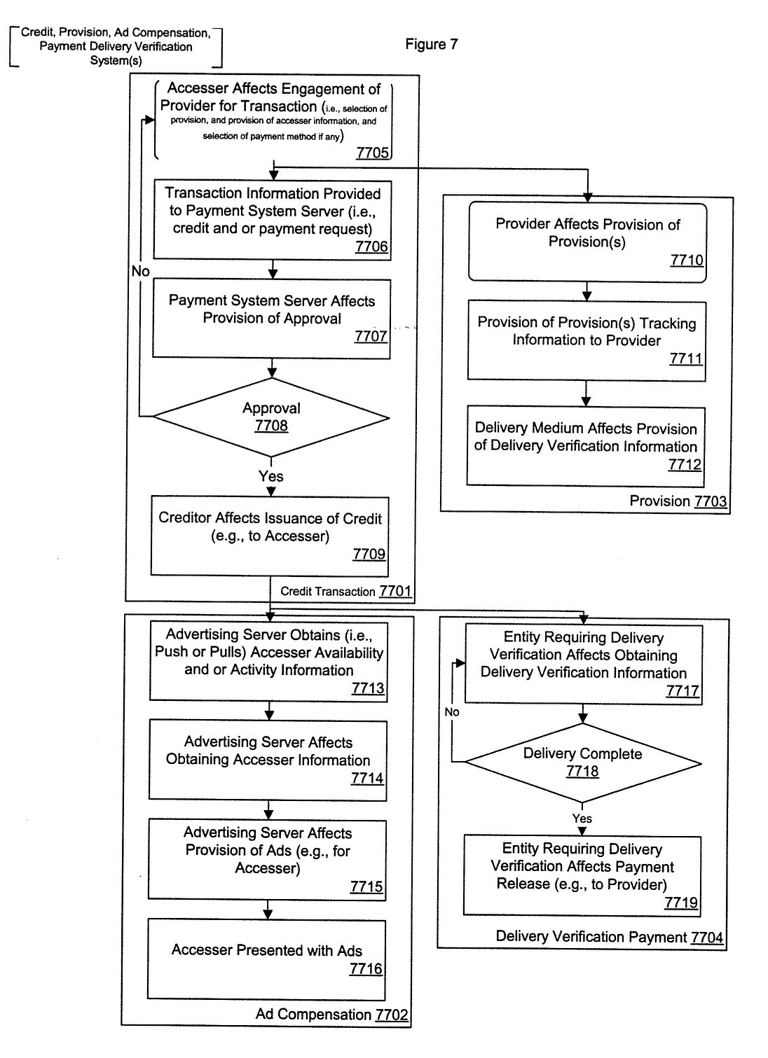

FIG. 7 illustrates a credit transaction 7701, provision 7703, ad compensation 7702, and payment delivery verification 7704.

A credit transaction 7701 may comprise transaction engagement 7705, transaction information provision 7706, approval provision 7707, approval 7708, and credit issuance 7709. A credit transaction may commence when an accesser affects the engagement of a provider for a transaction 7705. This engagement process was illustrated for purposes of example, and not limitation, in FIG. 5. Typically it includes the selection of provision(s), the provision of accesser information, and selection of a payment method if required. Accesser information may include any information regarding the accesser such as, but not limited to name, address, biographical information, transactional information, and the like. Payment method selection(s) may include any supported methods of payment such as, but not limited to credit cards, wire, debit cards, credit auctions, and or the like.

Upon transaction engagement 7705, transaction information may be provided to a payment system server 7706. Transaction information preferably provided to a payment system server may contain information such as, but not limited to a credit and or payment request, and or the like.

Upon transaction information provision 7706, the payment system server may affect the provision of credit approval 7707. Accesser information may be accessed by a payment system server from an accesser database and reviewed for determination of credit approval. Conventional credit approval techniques such as credit rating information, credit limit, and factors of the like may be employed for approval determination.

If accesser credit is not approved 7708, the payment system server will deny credit to the accesser and not provide approval to the provider. At that point, the provider may reject the accesser, and the accesser may recommence transaction engagement.

Alternatively, if accesser credit is approved 7708, a creditor affects the issuance of credit to the accesser 7709. The payment system server may affect the issuance of credit on behalf of the creditor and or the creditor may issue credit directly to the accesser. Similarly, the payment system server may affect payment to the provider on behalf of the creditor and or the creditor may issue credit directly to the provider. The payment system server may also provide the provider with an approval or denial and or confirmation of the credit request and or issuance.

Upon transaction engagement 7705, provision of provision(s) may occur 7703. However, preferably, provision of provision(s) will not occur until completion of the credit transaction 7701. Provision of provision(s) may comprise provision of provision(s) to a delivery medium 7710, provision of tracking information, and delivery verification 7711. A provider may affect the provision of provision(s) to a delivery medium 7710. Upon provision of provisions 7710, provision(s) tracking information may be provided by the deliver medium to the provider 7711. Typically, in the case of courier services and the like, a numerical code is provided which may be used by payment system servers and or creditors for purposes of tracking provision delivery on systems such as but not limited to courier web tracking services and or the like. Upon provision of provisions 7710, the delivery medium may affect the provision of delivery verification information 7712. A delivery verification server 6615 of FIG. 6 may be configured to obtain the delivery verification information verifying accesser receipt of provisions upon the delivery verification server's obtaining a delivery verification request from either a payment system server and or creditor. The payment system server and or creditor may make a delivery verification request of the delivery verification server because a provider may provide the creditor and or payment system server with accesser provision tracking information provided by the delivery medium.

Upon the completion of a credit transaction 7701, ad compensation 7702 may commence. Traditionally, merchants, i.e., providers, must pay credit card companies and or credit card company affiliates a charge for facilitating a transaction initiated by a purchaser, i.e., accesser. Ad compensation may be employed in lieu of and or as a compliment to a provider charge by an electronic payment system. Thus, the credit issuer(s) and or affiliates would receive compensation from advertising revenue streams provided by the ad compensation system. Ad compensation may comprise an advertising server obtaining accesser activity and or availability information 7713, typically, from a provider.

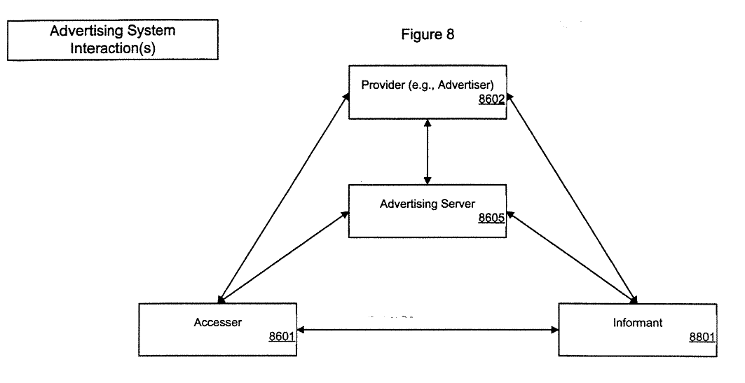

Upon obtaining accesser information 7713, the advertising server affects obtaining accesser information 7714. Typically, the advertising server may access an accesser database kept by an informant 8801 of FIG. 8. The accesser database may maintain any accesser information, transactional, identifying, biographical, and or the like. The advertising server may employ accesser availability and or activity information 7713 to query the accesser data and obtain full accesser information. Further, the advertising server may provide accesser availability and activity information to the accesser database.

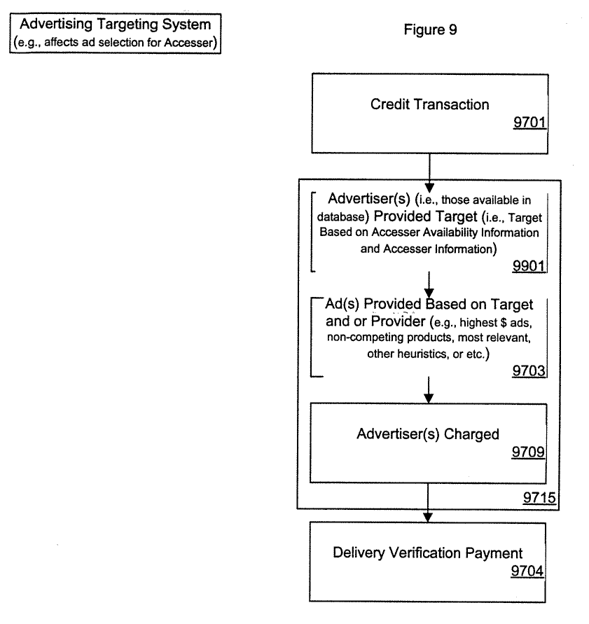

Upon having obtained full accesser information 7714, the advertising server may affect the provision of ad(s) 7715, typically for the accesser. The advertising server may employ numerous heuristics for selecting ad(s) for the accesser; e.g., see FIG. 9. The advertising server may employ conventional marketing heuristics. Preferably, the accesser information is employed to better target ad(s) for the accesser. An advertising database 171719 of FIG. 17 may house ad(s) for selection by the advertising server. Employing a selection heuristic and basic data processing retrieval techniques, ad(s) may be obtained from the advertising database.

Upon the provision of ad(s) 7715, the accesser is presented with ad(s) 7716. Ad(s) may be provided to the accesser employing standard data processing web techniques such as, but not limited to: sending web page(s) containing retrieved ad(s) in the form of web banner ad(s) to the accesser's web browser, and the like.

Upon the completion of a credit transaction 7701, delivery verification payment 7704 may commence. Traditionally, credit providing entities, e.g., credit card companies and affiliates, provide merchants, i.e., providers, with payment after a predetermined period of time; i.e., typically a month later. Traditionally, credit providing entities charge providers a greater amount for facilitating a transaction by providing an accesser with credit when there is no accesser signature tied to the transaction to compensate for the greater potential of fraudulent transactions. Delivery verification payment may be used to release payment upon verification of provision of provision(s) to the accesser. Delivery verification payment may comprise obtaining delivery verification information 7717, determination of delivery completion 7718, and affecting payment release 7719.

Upon the completion of a credit transaction 7701, an entity requiring delivery verification affects obtaining delivery verification information 7717. Typically, the payment system server and or a creditor will make a delivery verification request of a delivery verification server that may obtain delivery verification information from a delivery medium. Delivery verification information obtained will reflect if an accesser has obtained provisions provided by a provider. Delivery verification information may further provide details such as but not limited to if an accesser signed for the provision(s), date and time of provision receipt, and or the like.

Upon obtaining delivery verification information 7717, if the delivery is not complete 7718, the requiring entity may seek to obtain updated delivery verification information at any given time interval, or not at all. Alternatively, upon obtaining delivery verification information 7717, if the delivery is complete 7718, the requiring entity may affect payment release 7719, typically to the provider. After payment provision, the provider may obtain payment.

Various Advertising System Interactions

FIG. 8 illustrates various advertising system interactions. An advertising server 8605 acts as an in-between for: provider(s) 8602, accesser(s) 8601, and or informant(s). The accesser is a target of advertising by the advertising server. The advertising server may either provide ads directly to the accesser and or provide ads to be fed to the accesser through third parties such as but not limited to provider(s). The accesser is also the target of information harvesting by provider(s), the advertising server, and or informant(s).

Informant(s) are entities that collect data regarding accesser(s). Informant(s) collect accesser information employing standard data processing information collection techniques to record identity, transactional history, biographic history, geographic history, and the like. Informant(s) record accesser information in accesser database(s). Advertising server(s) and or provider(s) may employ similar techniques to record accesser information. Informant(s) may be employed by accesser(s), advertising server(s), provider(s). Informant(s) may be queried and provide accesser information to a requesting entity. Preferably, the advertising server will query the informant to obtain accesser information. Informants may gather information about accessers from accessers, providers, advertising servers, and the like. The advertising server may employ obtained accesser information for purposes of targeting ad(s) for an accesser.

Advertising Targeting System

FIG. 9 illustrates an advertising targeting system. An advertising targeting system may be employed as part of an ad compensation system 7702 of FIG. 7. Particularly, the advertising targeting system of FIG. 9 may be employed when an advertising server affects the provision of ads 7715 of FIG. 7, 9715.

Upon completion of a credit transaction 7701 of FIG. 7, 9701, advertiser(s) may be provided with target(s) 9901. Advertiser(s) information may be maintained, along with advertiser ad(s), in and advertising database 171719 of FIG. 17. The target is based on accesser availability information obtained from an advertising server 7713 of FIG. 7.

Upon target provision 9901, ad(s) may be provided based on the target and or provider 9703. Provision of ad(s) may be accomplished similar to other provisions 7703 of FIG. 7. Ad determination and or selection may be based on numerous heuristics such as but not limited to: target desirability, random, frequency, location, provider provision conflict avoidance, last purchase relatedness, and or the like.

Target desirability may be determined employing numerous heuristics. Target desirability may be determined employing standard credit rating techniques employing factors such as but not limited to credit history, credit availability, current credit extension, and or the like. Target desirability may be expressed and or embodied in a ranking and or rating. Integrating factors such as purchasing propensity profile information, and or the last provision obtained (i.e., purchased) may further enhance this target desirability ranking. Employing standard statistical techniques such as frequency, correlations, and or like analysis a target desirability ranking may be provided for any and all accessers. Having target desirability rankings allows the advertising server to select ads from advertisers wishing to pay more or less for particular desirability rankings.

Of course, ads may be selected simply at random, at specified provider locations, and or with specified (i.e., paid for) frequencies.

Alternatively, a provider provision conflict ad selection heuristic may be employed. Upon completion of a credit transaction 7701 of FIG. 7, a provider supplying an accesser (i.e., sponsoring) for ad targeting may prefer to have ads for provisions (i.e., products, services, information, et al.) from third parties that do not compete with the provider's offerings. An advertising system server may prevent the selection of ads from an advertising database that conflict with offerings from a sponsoring provider. This conflict check may be accomplished employing standard data processing techniques such as but not limited to: string, compare, concatenate, sort techniques, and the like. An advertising server may query a provider database and obtain offerings, query an advertising database of advertisers, and not select ads with competing offerings. Alternatively, sponsoring providers may provide specific advertiser(s) and or advertisements they do not wish to sponsor; this banned list of ads and advertisers may be saved in their record in the provider database and used by the advertising system server to prevent the selection of banned ads.

Alternatively, based on the last purchases of the accesser, the advertising system server may select ads. Employing accesser information about prior purchases, and or the latest purchase, the advertising system may select ads to complement the prior purchases. The selection of relatedness may be accomplished by establishing a database of pairings of items and relatedness rankings. For example, if an accesser just bought a car online, the advertising system server might select car insurance ads for accesser provision.

Furthermore, any and all the above heuristics may be combined in various manners. Each heuristic may affect an accesser's desirability ranking to advertisers. For example, an accesser that just bought a car with a high credit rating may be selected to receive numerous ads from an insurance company even though ads existed in the advertising system server for floor mats because the provider of the car banned floor mat ads from its site.

Upon the determination of ads employing any of the above selection heuristics and or the like, the advertising server affects the provision of the selected ads for the accesser 7715 of FIG. 7, and then the accesser is presented with the adds 7716 of FIG. 7.

Upon the provision of ads 9703, advertisers may be charged 9709; similarly to how creditors may affect the issuance of credit 7709 of FIG. 7 to accessers (i.e., in this case the advertisers are accessers) by employing a payment system server if so desired. Of course, advertisers may pre-pay for ad dissemination as well. Furthermore, advertiser's may be charged nothing for ad provision; if an ad provision has no associated charge, no advertiser charges will be affected. Similarly to other provisions, ads may also employ delivery verification payment 7704 of FIG. 7, 9704 for payment release of charges.

An example transaction from one alternative embodiment of the system would allow: provider's systems to totally customize the presentation of web pages for accessers before serving them to accessers based on criteria maintained in a database tracking said criteria. The tracked criteria may be information such as, but not limited to: demographics, socioeconomics, sex, age (which may also be determined by his or her social security number), the accesser's virtual inventory determined by previous purchases, previous ad effectiveness measurements, previously viewed materials from other wed sites, linked accounts to other people, and or the like.

Further illustrating the example transaction from one alternative embodiment a payment system server record may indicate that a virtual inventory for Jane Doe to be: Jane Doe's identity is anonyfied to record #182367287, her age is 55, and she is from Aspen Colo.; her virtual inventory might comprise: skis, back massager from an online retailer Sharper Image, payment for her husband's cardiologist, mortgage for new house, new computer from online retailer Dell, procurement of direct deposits of $20.00 a month.

Further illustrating the example transaction from one alternative embodiment of a payment system server record may indicate that a previous virtual inventory for Jane Doe to show: a like of travel magazines about the South Pacific.

Further illustrating the example transaction from one alternative embodiment of a payment system server record may indicate that a previous ad effectiveness measurement for Jane Doe to be: a 98% chance of buying luxury goods when on sale.

Further illustrating the example transaction from one alternative embodiment of a payment system server transaction, a transaction might be: Jane Doe logs onto an online store on the Internet. The providers web site detects that the customer is a payment system server customer. Before providing the web page to the accesser, the web site pre-constructs and then provides the web pages. Then Jane Doe views the first web page.

Further illustrating the example transaction from one alternative embodiment of a payment system server transaction, a web page profile target result might be: a Web Page with a banner ads reading: “US air tickets to the Islands 50% off;” “Welcome to the worlds largest store that specializes in luxury goods for less,” “See our site for decorating your new house with a Rocky Mountain Flare,” “New improved back massager with heating element to reduce aches and pains only $19.99,” “Vuiton luggage set—buy now and pay no interest for one year,” and “News Content: NY Times reports new drug for men with heart problems.”

Ad and Target Provision System

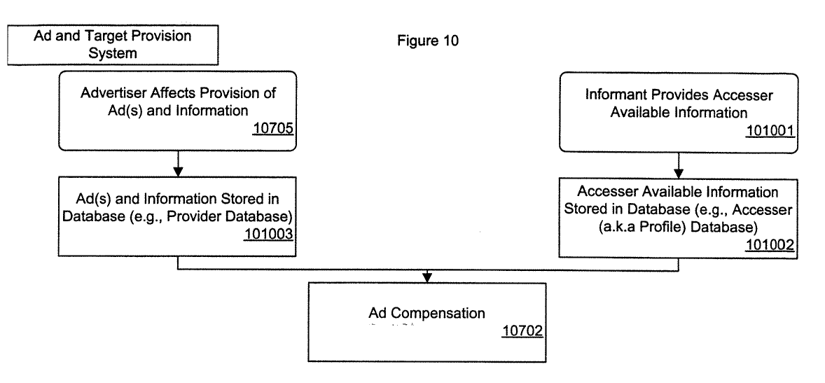

FIG. 10 illustrates an ad and target provision system. Advertisers may require a facility with which to provide ads to an advertising server. Furthermore, an advertising server may require a facility with which to obtain and or collect information for targeting accesser(s). Advertiser(s) may affect the provision of ad(s) and information 10705. In essence, here an advertiser becomes an accesser and engages in a transaction 7705 of FIG. 7, 10705 with the entity controlling the advertising system server who in this case becomes a provider of advertising services. The advertiser may commence transaction engagement in a manner similar to that shown in FIG. 5, except the advertiser will provide ads for placement in the web form employing standard data processing techniques such as but not limited to javascript applets for uploading of data from an accesser web browser, and or the like. Upon the provision of advertiser ad(s) and information 10705, the advertising system server affects the storage of advertiser ad(s) and information in an advertiser database 101003. At this point, the advertisers themselves, who are currently acting like an accesser, may optionally become the targets of an ad compensation system 7704 of FIG. 7, 10702.

Asynchronously, to the aforementioned ad provision system 10705, 101003, targeting information provision may occur 101001, 101002. An informant may provide accesser activity and or availability information 101001. Upon the provision of activity and or availability information 101001, the advertising server, or other information tracking entity such as another informant, may affect the storage of accesser activity and or availability information in an accesser database 101002. At this point, the informants may optionally become the targets of an ad compensation system 7704 of FIG. 7, 10702.

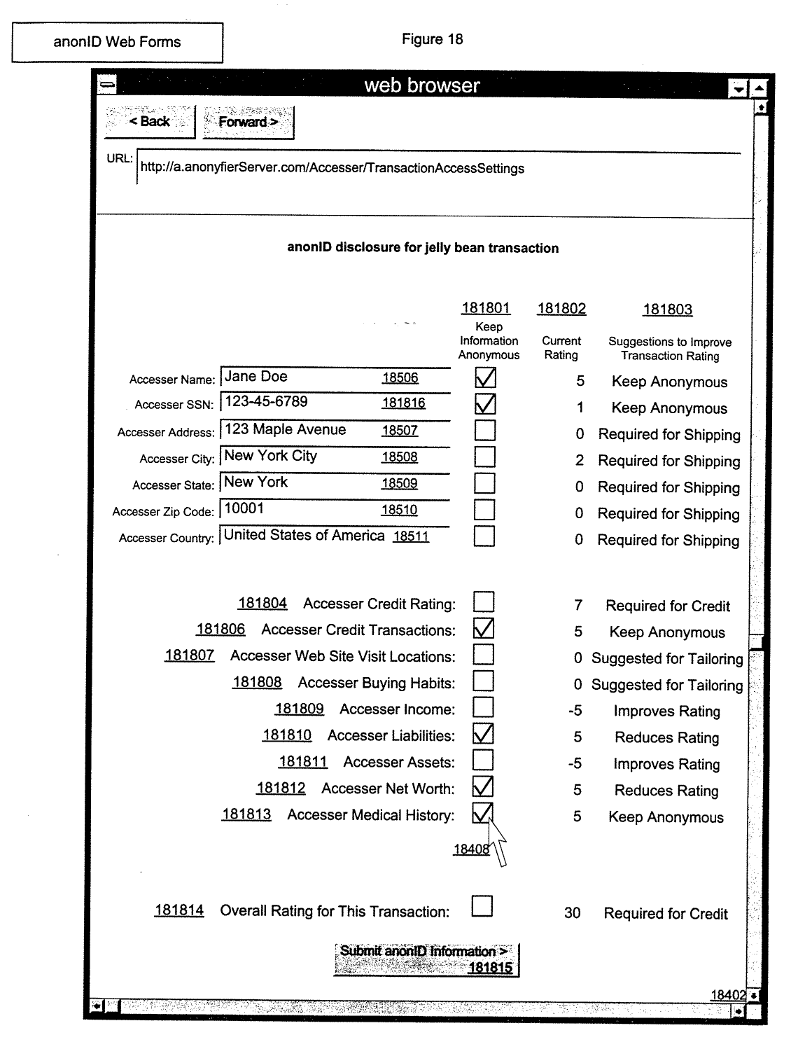

FIG. 11 illustrates various anonyfier interactions. An anonyfier server 111101 may separate accesser identity information from accesser transaction information. Furthermore, the anonyfier may securely protect and or prevent information requesting entities 111102 from obtaining and or realizing the identity of an accesser 11601 while still providing the information requesting entity with determined and or limited accesser transactional information; e.g., see FIG. 18.

Employing conventional cryptographic techniques, an accesser may identify itself to an anonyfier. For example, in one embodiment, an anonyfier may identify an accesser by verifying a digital certificate 111103b provided by the accesser. Thus, an accesser of an information requesting entity may provide the information requesting entity with an encrypted digital certificate 111103a, which the information requesting entity may relay to the anonyfier server along with its own digital certificate 111103c. Conversely, the information requesting entity may provide the accesser with an encrypted digital certificate 111103a, which the accesser may relay to the anonyfier server along with its own digital certificate 1103b. The anonyfier server may then verify accesser and or information requesting entity identity and provide the information requesting entity with determined and or limited accesser transactional information without accesser identification information. Thus, for example, an accesser visiting a merchant and engaging in a transaction for jelly beans (i.e., continuing the example in FIG. 5), may limit identifying information disclosure; e.g., FIG. 18.

Web Forms

FIG. 18 illustrates anonID web forms. This illustration is for purposes of example only, and in no way should be considered a limited application and or implementation of the present contrivance. The transaction engagement commenced in FIG. 5 may be concluded with the provision of anonyfied accesser information by providing the provider of FIG. 5 with information released by an accesser controlling anonyfier server disclosure via an anonID web form 18402. The accesser may traverse to the anonID web form upon having engaged a submit anonID button 5516 of FIG. 5. In the anonID web form the accesser may select information to keep anonymous by engaging check boxes 181801 and or any like facility with a cursor 18408.

An anonID web form may contain information fields containing and or representing identifying information such as, but not limited to accesser: name 18506, social security number 181816, address 18507, zip code 18510, medical history 181813, and or the like. An anonID web form may also contain information fields containing and or representing non-identifying information such as, but not limited to accesser: city 18508, state 18509, country 18511, credit rating 181804 (typically a numeric value), credit transactions 181806, web site visit locations 181807, buying habits 181808, income 181809, liabilities 181810, assets 181811, net worth 181812, overall transaction rating 181814, and or the like.

All of the information fields may have an associated current rating 181802. Engaging or disengaging anonyfication 181801 of information fields will affect the current rating. For example, by not providing her name, Jane Doe may incur a five point rating for that field because creditors and providers are wearier about engaging in a transaction with an anonymous entity. Had Jane not anonyfied her name 18506, 181801, her score current rating score may have been zero for her name 1802, 18506 if her name had a good reputation rating with the jelly bean provider; or her current rating may have been ten if she had a bad reputation rating with the jelly bean provider. Thus, Jane Doe, i.e., the accesser, may improve or worse her overall rating for the jelly bean transaction 181814, 181802 by selecting what information to keep anonymous 181801. In this example, a lower overall numeric score 181814, 181802 would result in a better overall accesser credit rating; however, many other ranking and rating systems may be employed. An anonyfier server, and or a payment system with anonyfication facility may also provide the accesser with suggestions to improve ratings 181803.

In the example web form for Jane Doe, Jane has chosen to not provide the jelly bean provider with her name, 18506, 181801, her social security number 181816, 181801, her accesser credit account 181805, 181801, her accesser credit transactions 181806, 181801, her accesser liabilities 181810, 181801, her accesser net worth 181812, 181801, nor her accesser medical history 181813. This yields a transaction rating of thirty for Jane Doe 181814, 181802. The accesser may affect the provision of information limited by her disclosure selections 181801 and or transaction rating 181814, 181802 to creditors, payment system servers, and or providers by engaging a button to submit anonID information 181815. Based on the transaction rating, a payment system server, creditor, and or provider may decide to approve a transaction and commence transaction engagement.

System and of Anonyfier Interactions

In FIG. 11, an accesser may affect the provision of information limited by her disclosure selections 181801 of FIG. 18 and or transaction rating 181814, 181802 of FIG. 18 to information requesting entities 111102 such as but not limited to creditors, payment system servers, and or providers by engaging a button to submit anonID information 181815 of FIG. 18. In one preferred embodiment, the disclosure of anonID information to an information requesting entity is accomplished by: encrypting an accesser digital certificate, an information requesting entity identifier (such as but not limited to an IP address or digital certificate 111103a obtained by the accesser from the information requesting entity), accesser selections of information to keep anonymous 181801 of FIG. 18, and any required accesser encryption keys; all of which once encrypted is provided to an anonyfier server; i.e., an accesser request to provide anonID information 11104 to an information requesting entity. The anonyfier server may decrypt this request to provide anonID information to an information requesting entity 111105. The anonyfier server may verify the legitimacy of the request by verifying the accesser digital certificate. If the accesser request is not legitimate, no information will be provided. The anonyfier may then provide information selected for disclosure 181801 of FIG. 18 from an anonID database; the anonyfier my have to employ an encryption key provided by the accesser in the accesser request to provide anonID information 111104 to decrypt certain identifying information field in conjunction with anonyfier keys. Before the anonyfier may provide the anonID information with a transaction rating and its own digital certificate all encrypted to the information requesting entity, the anonyfier will verify the legitimacy of the information requesting entity by requesting a digital certificate 111103c from the information requesting entity and comparing it to the digital certificate purportedly supplied by the information requesting entity to the accesser 111103a that was provided to the anonyfier in the accesser request to provide anonID information 111104. If the identity verification information provided to the anonyfier 111103a, 111103b, 111103c is not legitimate, no information will be provided. Upon identity verification, anonID information is encrypted with the anonyfier's and accesser's digital certificates and provided to the information requesting entity 111105. The information requesting entity may then obtain the encrypted anonID information, decrypt it, and make use of it.

Alternatively, rather than sending the encrypted digital certificate to the information requesting entity for relay to an anonyfier server, the accesser may have the encrypted digital certificate provided directly to the anonyfier server. Of course many alternative embodiments exist employing conventional cryptographic techniques to provide anonID information to an information requesting entity and ensure identity through standard identity verification techniques.

Anonyfication System

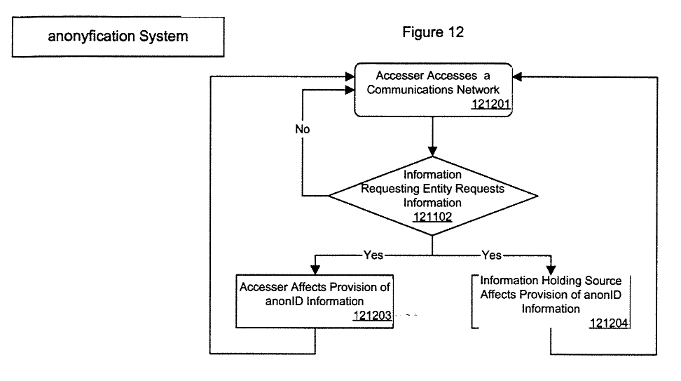

FIG. 12 illustrates an anonyfication system. An accesser wishing to maintain anonymity and employing the services of an anonyfier, said accesser may access a communications network 121201. If the accesser navigates to an entity not requesting information 121102, then the accesser may continue to access and navigate a communications network unfettered 121201. However, upon an accesser navigating to an information requesting entity 121102, an anonyfier server may protect the accesser's identity by affecting provision of anonID information 121203, 121204. Upon an information request 121102, an information requesting entity may obtain anonID information from either an accesser 121203 and or an information holding source 121204 such as but not limited to an informant, an anonyfier server, payment system server with anonyfier services, and or the like.

AnonID information is accesser information (i.e., any information related to an accesser) with no accesser identifying information except a non-identity disclosing identifier such as, but not limited to a digital certificate. Identifying information is any information that may be employed to particularly identify a particular individual accesser; for example, a name, a social security number, or even a street address may be used to identify a particular individual while a salary, credit rating, or purchase description (without more) will not particularly identify an individual. Preferably the digital certificate is changed from time to time. AnonID information provides the information requesting entity accesser transactional information while not violating and or exposing accesser identity. This allows information requesting entities to make queries for transactional information of an information holding source with regard to the accesser, and or aggregates of accesser, all without actualizing accesser identity.

All identifying accesser information is preferably double key encrypted in an anonID database that may be accessed by an anonyfier server. The anonyfier maintains only one key and may not access or decrypt the identifying information without the provision of the other encryption key that may only be provided by the accesser on a per transaction basis.

Furthermore, accessers may establish what types of information is to be maintained anonymous and will require their approval for disclosure for those wishing to gain access; e.g., see FIG. 18. These settings may be changed on a per transaction basis employing web form check boxes, and or other facilities of the like; e.g., see FIG. 18.

Credit Effect Systemization

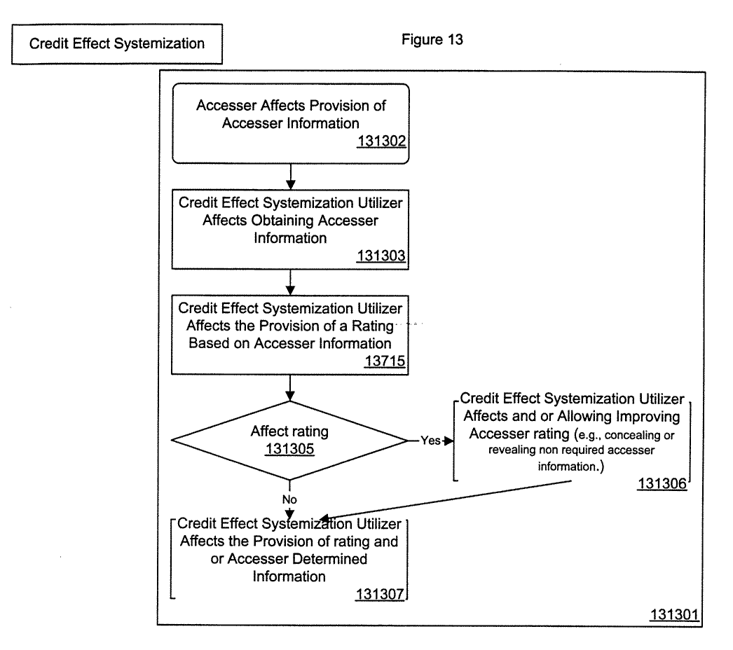

FIG. 13 illustrates a credit effect systemization 131301. A credit effect systemization utilizer (CESU) such as a provider, creditor, accesser, payment system server, anonyfier, and or the like may employ a credit effect systemization. Initially, an accesser may affect the provision of accesser information 131302. Typically this may be accomplished through web forms as exemplified in FIG. 5 and or FIG. 18. Upon provision of accesser information, the CESU may affect the obtaining of accesser information 131303. Upon obtaining accesser information, the CESU may affect the provision of a rating based on accesser information 131304. Accesser credit ratings may be based on numerous heuristics such as but not limited to: target desirability, random, frequency, location, provider provision conflict avoidance, last purchase relatedness, and or the like. This rating may be provided employing heuristics similar to those discussed in FIG. 7 for ad compensation provision 7715 and or FIG. 9 for the advertising targeting system 9715.

Upon provision of accesser ranking, an accesser may elect to affect her ranking 131305. In one embodiment, an accesser may elect to affect accesser ranking by opting to access an anonID web form. The accesser may opt to access an anonId web form by engaging a submit anonID button 5516 of FIG. 5. Upon election to affect accesser ranking 131305, the CESU may affect and or allow improving accesser ranking 131306. In one preferred embodiment, the CESU accesser ranking allowance and or effect 131306 is enabled by allowing the accesser to keep certain accesser information anonymous 181801 of FIG. 18.

In an alternative embodiment, the CESU may automatically affect accesser rankings by employing various heuristics, such as but not limited to ranking optimization, anonymity optimization, combinations thereof, and or the like.

Upon CESU accesser ranking allowance and or effect 131306 or upon a negative election to affect accesser ranking 131305, the CESU may affect the provision of ranking, e.g., 181814 of FIG. 18, and or accesser determined information 181801 of FIG. 18, 131307. Typically the provision of accesser determined information and or ranking is provided to CESU(s).

Credit Auction

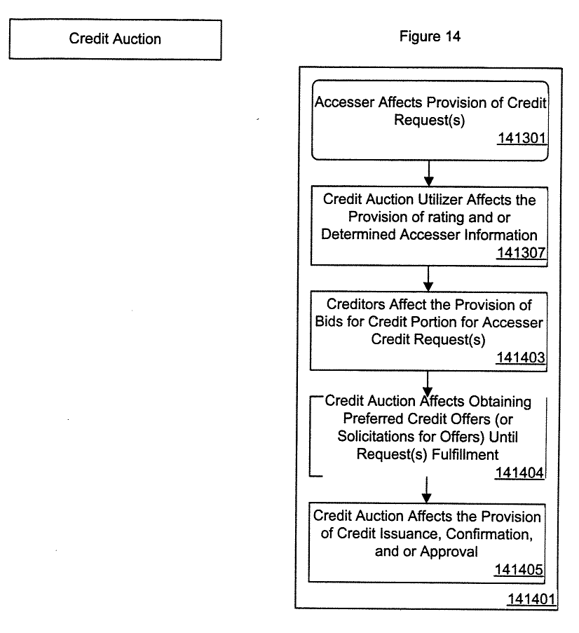

FIG. 14 illustrates a credit auction 141401. An information server, accesser, payment system server, anonyfier, and or the like may employ and or integrate a credit auction. Initially, an accesser may affect the provision of accesser credit requests 141301. In one embodiment, the provision of an accesser credit request 141301 may allow the accesser to affect their credit rating similarly and or through the credit effect systemization 131301 of FIG. 13. Typically, the credit request may be facilitated through a transaction engagement 6603 of FIG. 6 through a provider 6602 of FIG. 6 to a payment system server 6609 of FIG. 6.

Upon accesser affecting a credit request 141301, a credit auction utilizer may affect the provision of ranking and or accesser determined information 14307. A credit auction utilizer (CAU) such as a provider, accesser, creditor, payment system server, anonyfier, and or the like may employ a credit auction. The CAU may affect the provision of ranking and or accesser determined information 14307 similarly to how the CESU affects provision of ranking and or accesser determined information 131307 of FIG. 13; i.e., by employing anonID web forms as discussed in FIG. 18, and or the like.

Creditors may affect the provision of bids for accesser credit request(s) and or portions of accesser credit request(s) 141403. Creditors may provide a credit auction and or a payment system server with credit auction facility with creditor information and availability of credit and or conditions. For example, creditors may provide a credit auction with the right to approve credit requests for accesser's with credit ratings at a specified level, and with apportioned blocks of credit; e.g., a creditor X may provide $1 Million of credit for accessers with excellent credit ratings in blocks of accesser capital not to exceed $5,000 per accesser request at a 5.5% fixed annual lending rate. Thus if an accesser is requesting $15,000 in credit, creditor X may supply the first %5,000 in credit, assuming the 5.5% rate is the lowest offered to the accesser, and subsequent offers from other creditors may fulfill the remainder of the accesser creditor request for $10,000. Bids by the creditors may be in the form of offers and or provision of terms for credit auction offers; i.e., credit auction provision of suitable accesser credit requests. Conversely, credit auctions may solicit creditors for offers based on available accesser credit requests. Of course creditors may specify any number of terms, conditions, requirements, provisions and or the like when making credit bids available. In one embodiment, such conditions may be set by employing standard data processing techniques such as regular expressions working on XML based web forms with rule sets based on creditor requirements. Some non-limiting examples of heuristics factors that may be employed by creditors were discussed in FIG. 9; e.g., credit rating, outstanding debt, and or the like.

A credit auction may affect obtaining preferred credit offers and or preferred solicitations for offers (PCO/PSO) until accesser request(s) fulfillment 141404. PCO/PSOs are bids accepted based upon accesser requirements and or preferences. For example, an accesser may specify that she wishes to obtain $10,000 in credit employing anonID information hiding her name, social security number, credit history, et al. The accesser may not care if the credit is provided by a single credit provider, but does want the overall lending rate to be below 12.5% fixed. Based on the accesser's preferences, creditor credit offers at 10% one year variable rate credit offers would be turned down. Thus, only credit offers matching accesser preferences will be employed by the credit auction to fulfill the accesser credit request. The credit auction may attempt to fulfill an accesser and or creditor conditional offer for an indefinite or set period of time. If the set period of time elapses with no credit fulfillment, then a provider and accesser will not obtain approval for the accesser credit request.

Upon accesser credit request fulfillment 141404, the credit auction may affect the provision of credit issuance, confirmation and or approval 141405. Typically, the credit auction may affect a payment system server to issue credit 7709 of FIG. 7. Similarly, the credit auction may affect a payment system to provide credit request and or credit issuance approval and or confirmation 6608 of FIG. 6, 7708 of FIG. 7.

In one preferred alternative embodiment, a payment system server and or the credit auction server allows the preapproval by way of scoring, rating, and or ranking of the accesser (e.g., buyer requesting credit) before going into auction. Once at the auction, a creditor can bid on credit requests based on preapproval information. This allows the accesser to anonymously show the seller he or she has the ability to pay with out revealing their identity. Once a transaction has occurred, the creditor may decrypt the accesser's identity if the accesser allows it; however, typically the accesser will have to allow for identity access for credit provisions.

Credit Provision System

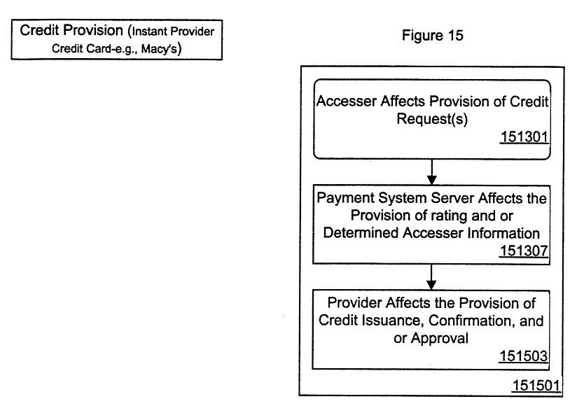

FIG. 15 illustrates a credit provision system 151501. Typically a provider and or creditor will employ a credit provision system. Traditionally, providers would extend credit to accessers by having then apply for provider credit cards and or the like; e.g., a Macy's credit card. The credit provision system allows for any provider to extend credit directly to an accesser as required at any time. An accesser may affect the provision of a credit request 151301, similarly and or through the credit effect systemization 131301 of FIG. 13.

Upon accesser affecting a credit request 151301, a payment system server may affect the provision of ranking and or accesser determined information 15307, similarly and or through the credit effect systemization 131307 of FIG. 13.

Upon obtaining accesser ranking and or accesser determined information 151307, the provider may affect the provision of credit issuance, confirmation, and or approval 151503. Typically, the provider may affect a payment system server to issue credit 7709 of FIG. 7. Similarly, the provider may affect a payment system to provide credit request and or credit issuance approval and or confirmation 6608 of FIG. 6, 7708 of FIG. 7. The primary difference, however, being that the provider 6602 of FIG. 6 will take the place of the creditor 6611. Therefore, the provider will issue credit to the accesser 6612 of FIG. 6, and receive payment from the accesser. Although, alternatively, the payment system server may act as an intermediary between the accesser and the provider.

Profile Provision and Profile Adaptive Behavior

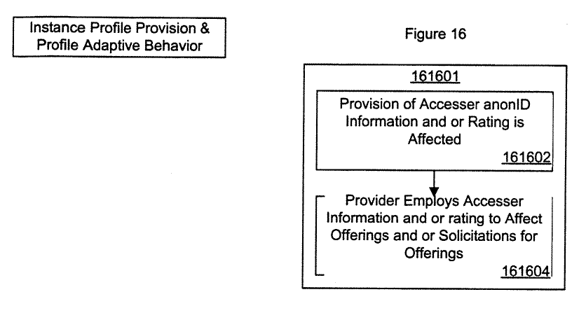

FIG. 16 illustrates an instance profile provision 161601 (IPP) and profile adaptive behavior (PAB) system 161604. The IPP/PAB allows a provider to tailor offerings to individual and or groups of accesser(s). Initially, an IPP/PAB system utilizer, typically an accesser, may affect provision of accesser anonID information 161602 to a provider. An IPP/PAB system utilizer (IPSU) such as a provider, accesser, creditor, payment system server, anonyfier, and or the like may employ an IPP/PAB system.

Upon provision of accesser anonID information 161602, a payment system server with anonyfying facilities may affect the provision of accesser determined information and or accesser credit rating information to a provider. Based upon this accesser determined information and or rating information, the provider may affect provision offerings and or solicitations for provision offerings 161604. For example, upon obtaining determined accesser and ranking information for accesser Y, the provider may notice that accesser Y will buy multiple bundled products when grouped together into a package discount. The provider may configure his or her information server to modify offerings and provide a custom package of goods at a discount dynamically for accesser Y based on accesser Y's profile.

Various Server Systems Interactions

FIG. 17 illustrates an overview of an embodiment of various server system(s) interaction(s). This embodiment is for purposes of illustration only, and in no way should be considered limiting. Information server(s) 17117 act as gateway for various electronic payment server module components 3125 of FIG. 3. Electronic payment server module components such as but not limited to advertising server module(s), delivery verification server module(s) 17123, payment server module(s) 17125, credit auction module(s) 17124, anonyfier server module(s) 17121, cryptographic module(s) 17120, databases 17119, 171719, and or the like may all interact with one another in various combinations employing standard data processing techniques.

In one typical embodiment, a payment system server may communicate with: an information server 17117 to allow providers, and accessers access; a delivery verification server module to provide a way to release funds to providers upon an accesser's receipt of provisions; a credit auction module to provide creditors, and accessers with a credit market, and or an anonyfier server module to allow accesser's to separate identity from transactional history. Also, payment system server has access to databases 17119a, 1119b of FIG. 1, 17119c, 171719 either through direct connection or through intermediary modules. A credit auction 17122 may communicate with: an information server directly, or preferably through a payment system server with creditors, accessers, and or the like; a delivery verification server may be employed to verify the electronic receipt of credits and or payments; an anonyfier server module may be employed as well. A delivery verification server may communicate with: an information server for anyone wishing to obtain notice of delivery verification information; a payment system server for release of payment; an advertising server 17122 to verify receipt of ad(s), and or advertiser payments; and an anonyfier server to maintain accesser anonymity while still providing provision receipt information. The advertising server may communicate with: an information server to provide advertising to accessers and or the like; a delivery verification server; an advertiser database for maintaining advertiser information and ad(s). An anonyfier server may communicate with: an information server module, a credit auction, a payment system, a deliver verification server, an advertising server, and a cryptographic server 17120. The anonyfier server employs the cryptographic server for processing cryptographic requests. The anonyfier may also communicate with an accesser 17119a, provider, and anonID database 17119c. In this particular embodiment, the anonID database is a part of an accesser database. Thus, the accesser database contains anonyfied accesser identity information that may not be viewed without both an anonyfier server key, and an accesser decryption key.

Any of the modules may access any number and or types of databases either through direct controller connection, e.g., FIGS. 1 and or 2, and or through other controllers via a communications network.

Non-Repudiation Converter

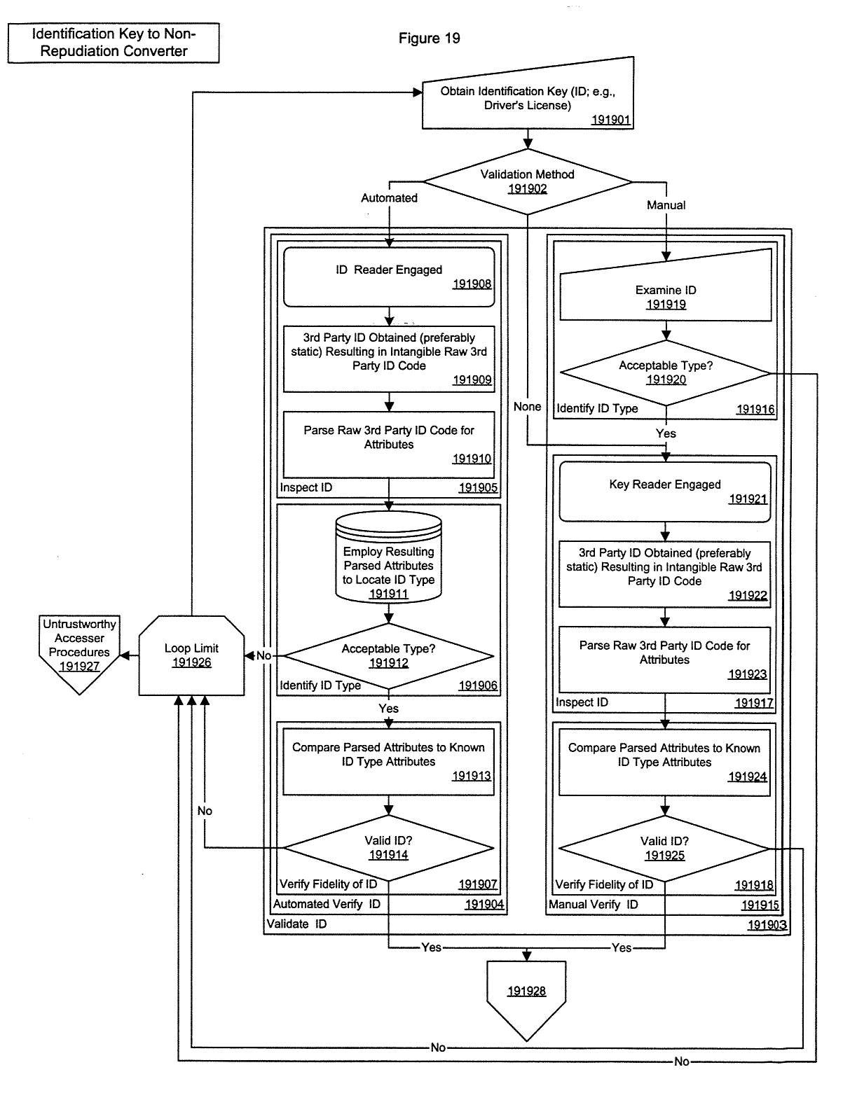

FIG. 19 illustrates an overview of an embodiment of an identification key (ID) to non-repudiation converter (i.e., non repudiation converter).

An accesser may provide an identification key 191901. An ID may be any item uniquely identifying an individual such as, but not limited to a driver's license with magnetic strip, a credit card, a library card, and or the like. The uniquely identifiable matter embedded into the ID, is a 3^{rd} party ID code. Upon obtaining a pre-existing ID, the non repudiation converter allows for selection of a validation technique 191902 to validate the ID 191903. The ID may be validated by automatically verifying the ID 191904, or manually verifying the ID 191915. Of course in alternative embodiments, establishments employing the non repudiation converter may opt to only employ automated verification or only manual verification.

Automatic verification of the ID 191904 includes inspecting the ID 191905, identifying the ID type 191906, and verifying the fidelity of the ID 191907. Upon obtaining the ID, an ID reader may be engaged 191908 upon the ID. A 3^{rd} party ID code may be obtained by way of an ID reader device such as, but not limited to card readers, disc readers, bar code readers, optical scanners, and or the like depending on the embodiment of the ID 191909; this may include a person hand keying an ID attributes (e.g., card numbers) into a computer system by way of a n input device (e.g., a keyboard). Upon engaging an ID reader upon an ID, the information read by the ID reader is scanned or parsed for a 3^{rd} party ID code 191910. Typically, 3^{rd} party ID codes have patterns identifying their source of origin. Those skilled in the art know the location of certain information codes embedded into Ids that identify the ID type 191906. Parsing the information employs standard data processing techniques such as string, compare, concatenate, sort techniques, and the like.

Upon parsing the 3^{rd} party ID code for attributes, the parsed attributes are used as tokens for querying a database of ID types 191911. If the attributes do not match a known ID type 191912, then the ID 191901 may once again be processed by the ID reader 191908. This rescanning may be repeated as long as a loop limit 191926 is not breached. The loop limit may be specified and may be infinite. If the loop limit is breached, untrustworthy accesser procedures will be engaged 191927. However, if the attributes of the parsed 3^{rd} party ID code do match a known ID type 191912 in an ID type database 191911, then the 3^{rd} party ID code's fidelity will be verified 191907. Those skilled in the art know of the simple checksums that may be performed on 3^{rd} party ID codes that may be used to verify the fidelity of the ID. Upon having identified a known ID type in the ID type database, verification attributes associated with the identified ID type are retrieved from the database. These retrieved and known ID type attributes are used as a basis to compare with the parsed attributes 191913. If the known attributes do not match the parsed attributes 191914, then the ID is not valid and may be re scanned assuming a loop limit hasn't been breached 191926. However, if the parsed attributes match those of known ID type attributes in an ID type database, then the ID is valid and the parsed 3^{rd} party ID code may be passed for further processing 191928.

Manual verification of the ID 191915 includes identifying the ID type 191916, inspecting the ID 191917, and verifying the fidelity of the ID 191918. Manual verification differs primarily in that identification of ID type 191916 is a manual task. Upon obtaining an ID, someone needs to examine the ID 191919 and determine if it is an acceptable type 191920. Acceptable types are types that may be processed either through an ID reader, or manual entry. If the ID is not an acceptable type 191920, then a non repudiation converter may accept other IDs 191926 until a loop limit breach occurs 191926 or an acceptable form is identified. Upon identifying an acceptable ID type 191920, inspection of the ID 191917 and fidelity verification of the ID 191918 occur similarly as for automated ID verification 191904.

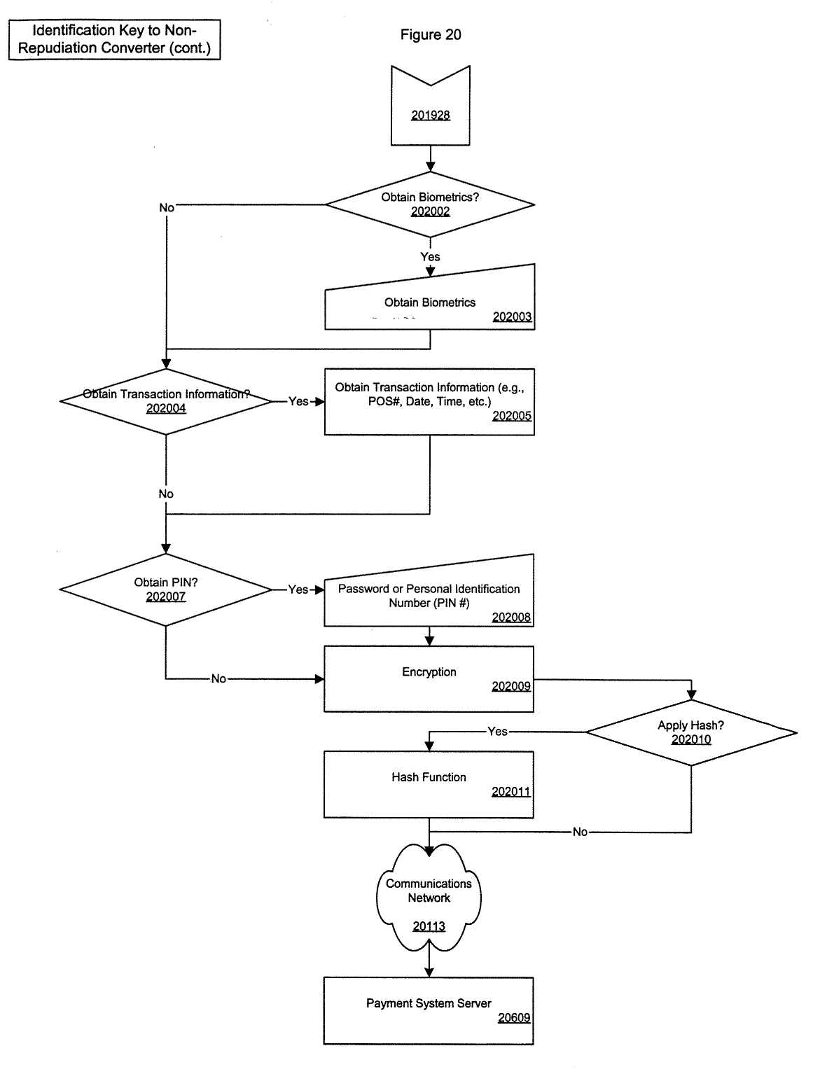

FIG. 20 further illustrates an overview of an embodiment of an identification key (ID) to non-repudiation converter (i.e., non repudiation converter). Upon validating an ID 191903, 191928 of FIG. 19, 201928, the non repudiation converter will take the intangible 3^{rd} party ID code and convert it into a secure form to be used with a payment system server 20609 as a non repudiation code. There is a direct correlation between the converted ID code, and the original 3^{rd} party ID code. The 3^{rd} party ID code at a minimum should be encrypted 202002, 202004, 202007, 202009. The form of encryption may be any of those mentioned in 2205 of FIG. 2, and elsewhere, as long as the proper and complementary decryption scheme is used for any particular encryption scheme. However, depending upon deployment resources, and the requirements of any particular payment system, biometrics 202003, transaction information 202005, personal identification numbers 202008, and hashing 202011 may augment the encryption to enhance security, if so desired.

Upon validating an ID 191903, 191928 of FIG. 19, 201928, the non repudiation converter may obtain biometrics 202002 if the desired function is desired or required. Biometric devices may include peripheral devices such as finger print scanners, retina scanners, and or the like. If biometric devices are present, biometrics may be obtained 202003, and used as a basis for converting the raw 3^{rd} party ID code. In an alternative embodiment, a biometric code derived from the obtained biometrics may be used without a 3^{rd} party ID code, itself becoming the basis for identification to non repudiation conversion. Upon obtaining the biometrics, biometric software will return biometric information that may be passed along with any 3^{rd} party ID code for further processing 202004. The biometric information returned from the biometric has the property of being unique to the subject upon which the biometric device was applied. Similarly, if no biometrics are obtained 202002, the 3^{rd} party ID code will be passed for further processing 202004. If desired, transaction information may be obtained 202004 for inclusion into generating a non repudiation ID. If not, information, namely a 3^{rd} party ID code and or biometrics, will be passed for further processing 202007. If desired, transaction information will be obtained 202005. Transaction information may include the date, time, point of sale (POS) number of a merchant, and or the like. Such transaction information may be obtained by merchants by way of credit card machines and or the like. Including the merchant transaction information would secure the non repudiation ID to a single merchant. Thereafter, a personal identification number and or password (PIN) may be obtained 202007. PINs may be obtained 202008 by standard key entry peripheral devices such as a keyboard, credit card terminal, and or the like. If no PIN is to be obtained, then the 3^{rd} party ID code plus any of the optional non repudiation enhancing information (i.e., biometrics and or transaction information) will be passed for encryption 202009. If a PIN is provided, then the PIN will be provided along with the 3^{rd} party ID code plus any of the optional non repudiation enhancing information. Any number of encryption algorithms may be chosen, and a preferred algorithm choice will depend upon deployment considerations such as national regulations limiting encryption strength, hardware resources, and complexity burden of operation minimization. Upon encrypting the 3^{rd} party ID code and any of the optional non repudiation enhancing information, optional post encryption manipulations may 202010 be applied. These optional post encryption manipulations may themselves also be encryptions. Applying hashing algorithms 202011 is desirable for increased security purposes. However, if no hashing has is applied 202010, then the encrypted 3^{rd} party ID code and any of the optional non repudiation enhancing information may be sent through a communications network 20113 to a payment system server 20609 for verification. Similarly, even if the information is hashed 202011, the non repudiation ID may be sent over the communications network 20113 to the payment system server 20609.

The payment system server upon obtaining the non repudiation ID may verify the validity of the non repudiation device by employing standard cryptographic techniques. In one example, the non repudiation ID may serve as a public key pair complement that will be sent to the payment system server with any payment information for unlocking. Upon obtaining the public key variant of the non repudiation ID, the payment server may decrypt the information and validate that the ID is on record as being valid, and if so send back an authorizing code to the merchant using the non repudiation converter. In an alternative embodiment, the merchant and payment system server have already agreed upon a key, and upon decryption the payment system server will verify that the encrypted information in the non repudiation converter ID is on file. The payment server may decrypt this information employing standard encryption techniques generally employing complimentary decrypting algorithms, and or applying decryption in the reverse processes as described thus far in FIG. 20. Upon successful decryption, the payment system server may compare the 3^{rd} party ID code (and if present any PIN, transaction information, and or biometrics) with information stored and available to the payment system server to verify the non repudiation ID. If any of the information does not match up to payment system server records, then any subsequent transactions may be repudiated.

The payment system server (and or any ancillary servers that may handle such functionality for the payment system server; i.e., cryptographic controllers of FIG. 2) may obtain and create the original key and or non repudiation ID code and or compliment by initially obtaining and or performing the encryption described above in FIGS. 19 and 20 locally on site or from an accesser's system.

In one embodiment, the payment system server operators may decide to employ drivers' licenses and PINs for the creation of non repudiation IDs. An accesser would go to a payment system server providing any requisite peripheral devices to swipe or otherwise enter in a driver's license number and then provide a PIN, both of which would be used as the basis for creating a pair of encryption keys. The private key would be saved on site at the payment system server. Merchants using the payment system server would be able to generate the public key pair compliment on demand by obtaining the driver's license number and PIN at the merchant's site through the use of a non repudiation converter.

By employing a 3^{rd} party ID, a payment system server may avoid the costs of creating a tangible ID as is the norm. Rather, by employing a non repudiation converter, the payment system server instead creates a non tangible version of the ID, namely the non repudiation ID, which is based off a tangible 3^{rd} party ID.

Closed Loop into Extra-Loop Resources Enablement System

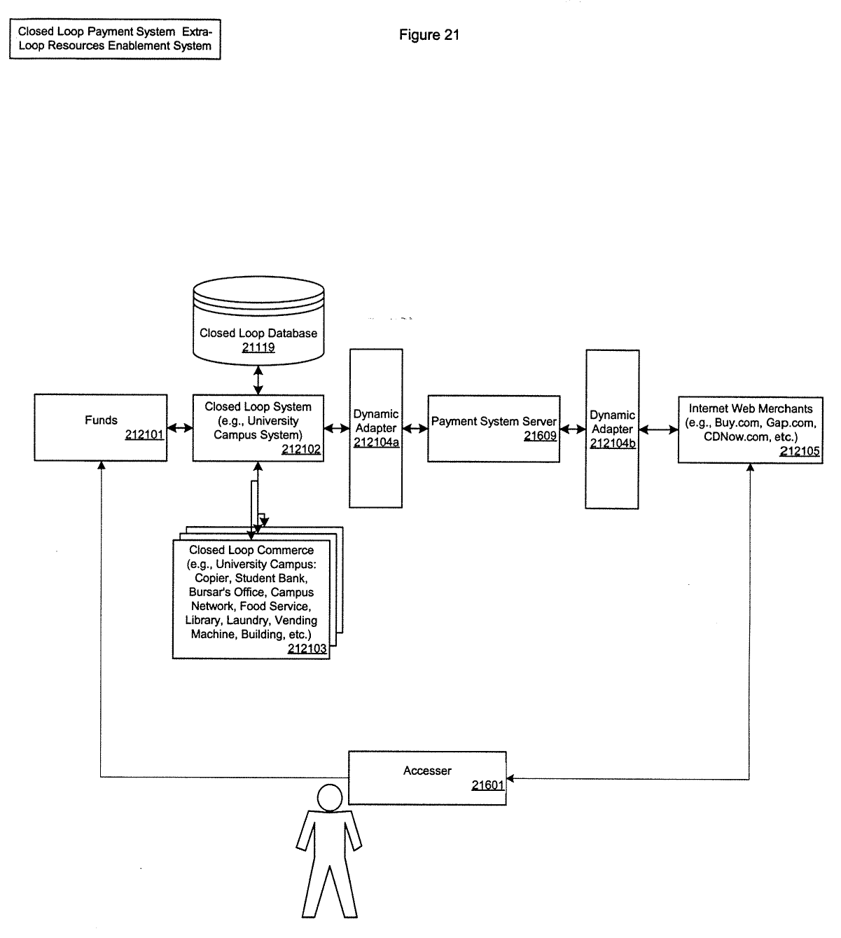

FIG. 21 illustrates an overview of one embodiment of a closed loop payment system extra-loop resources enablement system (ELRES).

Creating a secured payment transaction system requires a technology model that interfaces to both closed loop systems 212103 and merchants 212105. One example of a closed loop system is a university campus card system; meaning university systems do not support transactions that beyond the realm of the university. The present invention establishes a gateway that extends the realm of closed loop systems and merchants to beyond their traditional realms by establishing a platform that will interface with the a payment system server 21609 on one end (that may be interconnected with many other payment systems itself by way of a communications network, and or the like) and the merchants 212105 (that had no access to the closed loop and or other payment systems) on the other end. By adapting these limited systems to communicate and interact with other payment systems, the present invention provides following capabilities in one embodiment:

the ability to identify the user's balance to determine if the amount of funds available can be applied to the products and services being ordered (i.e., on-line verification of funds); the ability to enable the user to proceed through checkout by paying for provisions through his or her closed loop account (e.g., his or her university account); the ability to record the details of the transaction including payer, payee, data, time and amount of transaction; the ability to execute the settlement transactions between the closed loop system's bank and the merchant's bank; and the ability to assist the closed loop system, merchant, and or accesser in the reconciliation of settlement and transaction recording.

A conventional closed loop payment system 212102 may employ a database 21119 to track transactions limited to accepting funds 212101 from an accesser 21601 for closed loop related commerce 212103. In a typical closed loop system there would be no link or communications between a closed loop system 212102 and non affiliated (i.e., extra loop) systems (e.g., payment system servers 21609 and merchants 212105). In one embodiment, an ELRES employs a dynamic adapter 212104a that is integrated into the payment system 212102 and thus facilitating communications with a payment system server 21609. This allows the payment system server to act as a gateway for other merchant's and payment systems to access the funds and or credit 212101 originally limited to the closed loop system (e.g., Internet web merchants 212105 and or others of like). Other merchant systems tying and or communicating with payment system servers may similarly and individually be adapted 212104b. This expands the accesser's 21601 utility by freeing the accesser to employ funds 212101 originally limited to the closed loop system for other purposes (e.g., 212105) through the payment system server 21609.

Dynamic Adapter

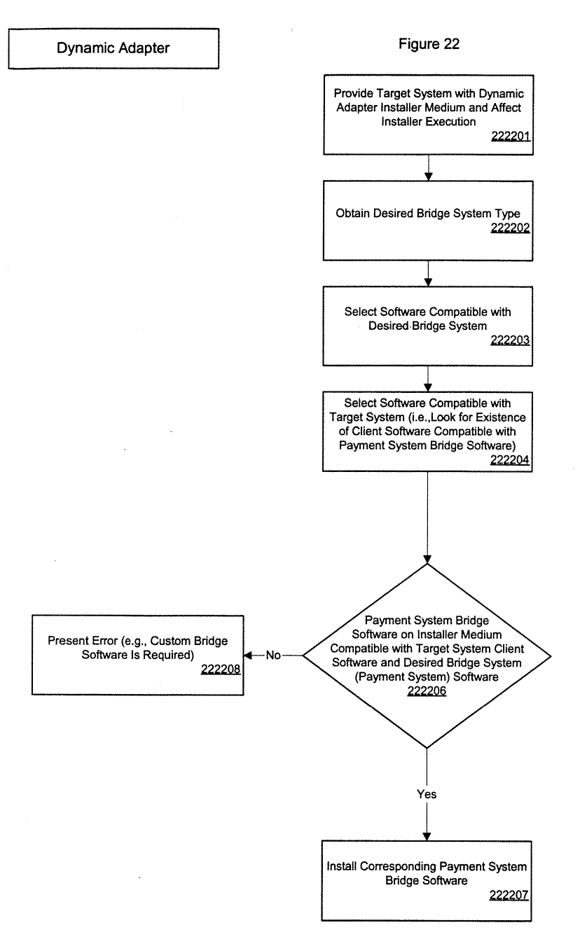

FIG. 22 illustrates an overview of one embodiment of a dynamic adapter. The dynamic adapter 212104 of FIG. 21 is a self installable API that either merchants 212105 of FIG. 21 and or closed loop payment systems 21609 of FIG. 21 may “plug & play” into their existing system (i.e., target systems). Upon installation and configuration of the dynamic adapter communications are established allowing the transfer of funds and other payment system functions through standard payment system electronic transfer techniques.

The dynamic adapter itself may be placed on a computer readable medium. Upon providing the computer readable medium containing the dynamic adapter and installer (i.e., installer medium) to either a closed loop payment system and or merchants (i.e., target systems), the dynamic adapter installer may be executed either automatically through a self executing script or executable, or execution may be affected by the installing party 222201. Upon executing the installer, the dynamic adapter installer analyzes obtains the identity of the desired bridge system (e.g., the payment system server 21609 of FIG. 21). The installer may obtain this identity by allowing a user to select potential system types from a pop-up menu, typing in the name in a text box, and or other like facilities that may obtain a token for searching 222202. Upon obtaining a token (e.g., string) representing the desired bridge system, the installer medium is searched for payment system bridge software compatible with the desired bridge system. The search may be accomplished by creating a table in which each payment system bridge software package entry has a corresponding list of compatible desired bridge systems and or target systems. Thus using standard data processing search techniques, the table (and or any other functionally equivalent data structures) may be searched for the instances of the token. All corresponding payment system bridge software will be selected on the basis of such a token search 222203. Thereafter, the dynamic adapter installer analyzes the system upon which it is executing (i.e., the target system). The installer contains a list of known payment and merchant systems and checks locations on the target system for the existence of any of the listed systems. For example, The Processing Network, Inc.'s SecureCharge; Virtual Merchant, Inc.'s Virtual Merchant; and or TouchNet Inc.'s E-commerce solution software all may be employed as (Internet) payment system bridge software bases. By creating a script that looks to see if particular isolated client payment system components are installed, the appropriate bridge software may be installed. Thus, the dynamic database adapter installer will run through the list of all known payment system bridge software, checking if the target system has such components signifying compatibility with the selected payment system bridge software 222203 thereby further narrowing selection 222204. Only the appropriate payment system bridge software is considered; namely payment system bridge software that may communicate with the desired bridge system 21609 of FIG. 21. If the installer finds payment system bridge software compatible with both the desired bridge system, and with system software and or other payment system client software residing on the target system 222206, then the installer will initiate the installation of the appropriate payment system bridge software package 2207. If, however, the installer does not find payment system bridge software compatible with either the target system or the desired bridge system 222206, then an error will be reported and a custom bridge will have to be developed 222208.

Alternative Embodiment of Payment System Interactions

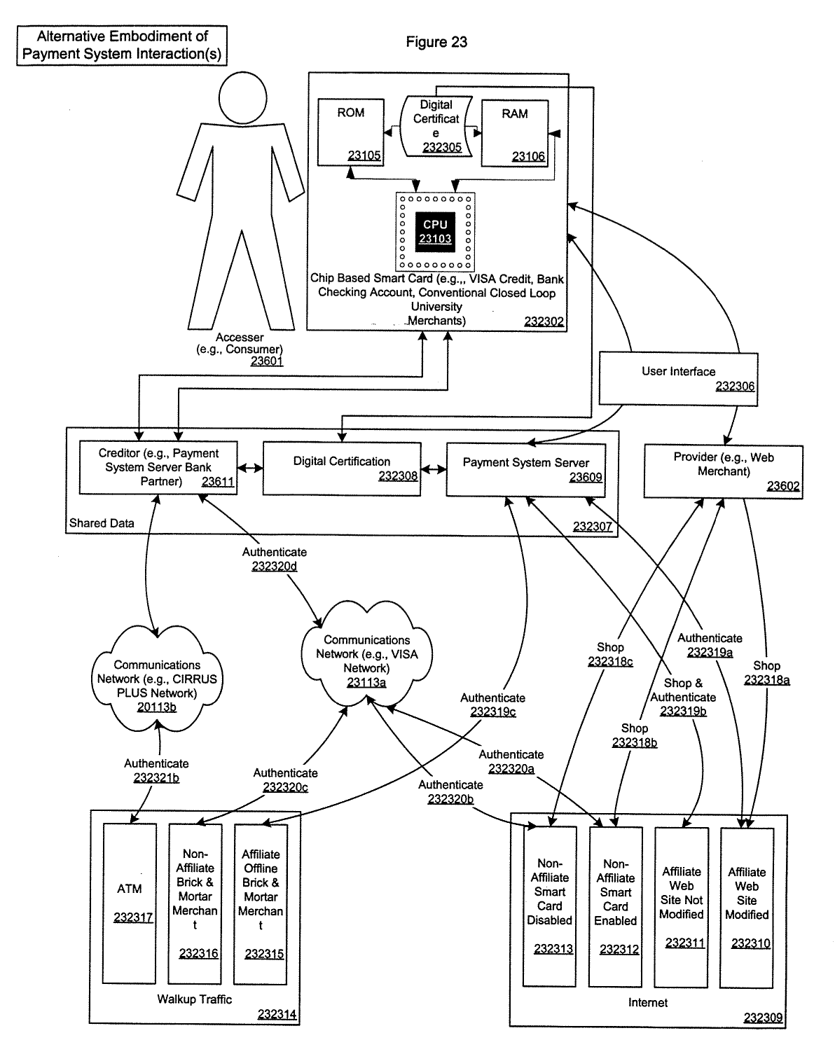

FIG. 23 illustrates an overview of an alternative embodiment of payment system interaction(s). An accesser 23601 may employ a chip based smartcard 232302 to access the various services provided by a payment system 232307. One embodiment of a smartcard 232302 may contain any number of electronic purses (i.e., E-purses). Examples of smartcards include Gemplus, Inc.'s of France, GemXpresso Lite, SAM for MPCOS-EMV, and GemProton cars. Smart cards may include a CPU 23103, ROM 23105, RAM 23106. Either the RAM or the ROM may hold the smartcard's digital certificate 232305. These smartcards control accesser funds, which may be released or depleted upon transaction completion changing the value in memory within the smartcard and or to smartcard linked accounts reflecting the purchase. Smartcards may contain an Operating System that supports a variety of security measures, Bi-directional Authentication, DES or Public Key Encryption, Elliptical Curve Algorithms, Anti-Tearing Flags, PIN/Passwords and Internal Random Number Generation for unique Digital Signatures, Session Journaling, and T=1 and T=0 protocols. Smartcards employ transfer protocols known to those skilled in the art.

Smartcards are like digital passports that carry consumers' digital certificates. Smartcards are portable secure keys that may be used between computer platforms and merchants. They may transported to wherever they are needed. Of course smartcard chips do not need to be in a physical card, they may be embedded in other devices and mediums, e.g., cell phones, PDAs, and or the like.

The accesser may use the smartcard through a user interface 232306; the user interface may be a user interface module 2117 of FIG. 2 and or a user interface device 2202b of FIG. 2. This may be accomplished through a peripheral device for interfacing with smartcards disposed in communication with the user interface and or through other ID to non-repudiation conversion facilities as discussed in FIGS. 19 and 20. This allows accessers to employ smartcards on the Internet 232309 even if the smartcards were originally designed to function only in conventional closed loop payment systems, which is discussed in greater detail in FIGS. 21-22. Similar to FIG. 6, an accesser may access a provider 23602, 6602 of FIG. 6 and or a creditor, e.g., a payment system server bank partner, 23611 by way of user interface 232306. However, the accesser may also provide transaction information directly to a payment system server 23609, which may be necessarily the case in closed loop payment systems adapted to act as a gateway as explained in FIGS. 21-22. An accesser may use a digital certification service 232308 such as, but not limited to an anonifier server 111101 of FIG. 11 for security purposes of validating the identity of the accesser and smartcard and associated accounts. The payment system server 23609, digital certification 232308, and creditor 23611 may all be disposed in communication with one another to pass information relating to payment and ensuring the validity of transactions. The accesser may then shop at both affiliated and non-affiliated web sites.

People and or entities may shop with various types of websites in the Internet 232309 including affiliated and non-affiliated sites that were either modified to work with a payment system server 23609 or not. Shopping at an affiliated website 232318a that is configured to interoperate with a payment system server 232310 will be authenticated 232319a with a payment system server 23609. Shopping at an affiliate merchant whose system has not been modified to interoperate with a payment system server 232311 may also be accomplished by shopping and authenticating 232319b through a payment system server 23609, which may be accessed through a user interface by the accesser.

Shopping 232318b at a non-affiliated merchant with smartcard facilities 232312 may be accomplished through a provider's web site 23602 via a user interface 232306 by the accesser. The merchant 232312 can then authenticate and obtain approval 232320a by providing smartcard information through a communications network, e.g., the VISA network, which will obtain further authentication and or approval 232320d from a creditor 23611, e.g., a payment system server and or a partner bank. The creditor 23611 may then authenticate the accessers' digital certificate 232305 with his digital certificate 232308 and or that of the payment system server. The creditor 23611 and the payment system server may then resolve payments and or approvals as already discussed throughout this disclosure.

Shopping 232318c at a non-affiliated merchant without smartcard facilities 232313 may be accomplished through a provider's web site 23602 via a user interface 232306 by the accesser. The merchant 232312 can then authenticate and obtain approval 232320b by providing smartcard information through a communications network, e.g., the VISA network, which will obtain further authentication and or approval 232320d from a creditor 23611, e.g., a payment system server and or a partner bank. The creditor 23611 may then authenticate the accessers' digital certificate 232305 with his digital certificate 232308 and or that of the payment system server. The creditor 23611 and the payment system server may then resolve payments and or approvals as already discussed throughout this disclosure.

Shopping at an affiliate merchant that is not online 232315, an accesser may make a purchase that is authenticated 232319c with a payment system server 23609, and may later be viewed with a user interface 232306. Similarly, an accesser may shop at a non-affiliated offline merchant 232316, but authentication is achieved through a communications network 23113a and further authentication 23230d occurs as already discussed above with regard to creditors 23611, digital certification 232308, payment system servers 23609 all of which may share data 232307 between one another as already discussed throughout the disclosure. Also ATM transactions 232317 may be authenticated 232321b through a communications network, e.g., Cirrus Plus Network, and authentication occurs similarly through a creditor 23611 as already discussed. Of course, smartcards 232302 may be charged and or accessed directly with a creditor 23611.

It should be understood that the above description is only representative of illustrative embodiments. For the convenience of the reader, the above descriptions have focused on a representative sample of all possible embodiments, a sample that teaches the principles of the contrivance. The description has not attempted to exhaustively enumerate all possible variations. That alternate embodiments may not have been presented for a specific portion of the contrivance, or that further undescribed alternate embodiments may be available for a portion, is not to be considered a disclaimer of those alternate embodiments. It will be appreciated that many of those undescribed embodiments incorporate the same principles of the invention and others are equivalent. Thus, it is to be understood that the embodiments and variations shown and described herein are merely illustrative of the principles of this contrivance and that various modifications may be implemented without departing from the scope and spirit of the contrivance.

1. (canceled)

2. A method for providing an accesser credit from a plurality of creditors, comprising:
receiving an accesser credit request;
receiving accesser credit history information;
providing a bid for partial fulfillment of the accesser credit request based on the accesser credit history information, the unfulfilled balance of the accesser credit request being fulfilled by a bid from another creditor.

3. The method of claim 2, wherein the step of receiving accesser credit history information includes a step of receiving accesser credit rating.

4. The method of claim 2, wherein the step of receiving accesser credit history information includes a step of receiving accesser credit history information and receiving accesser credit rating.

5. The method of claim 2, further comprising providing credit issuance.

6. The method of claim 2, further comprising providing credit confirmation.

7. The method of claim 5, further comprising providing credit confirmation.

8. The method of claim 2, further comprising providing credit approval.

9. The method of claim 5, further comprising providing credit approval.

10. The method of claim 7, further comprising providing credit approval.

11. A system for providing an accesser credit from a plurality of creditors, comprising:
means for receiving an accesser credit request;
means for receiving accesser credit history information;
means for providing a bid for partial fulfillment of the accesser credit request based on the accesser credit history information, the unfulfilled balance of the accesser credit request being fulfilled by a bid from another creditor.

12. The system of claim 11, wherein the means for receiving accesser credit history information is configured for receiving accesser credit rating

13. The system of claim 11, wherein the means for receiving accesser credit history information is configured for receiving accesser credit history information and receiving accesser credit rating.

14. The system of claim 11, further comprising a means for providing credit issuance.

15. The system of claim 11, further comprising a means for providing credit confirmation.

16. The system of claim 14, further comprising a means for providing credit confirmation.

17. The system of claim 11, further comprising a means for providing credit approval.

18. The system of claim 14, further comprising a means for providing credit approval.

19. The system of claim 16, further comprising a means for providing credit approval.

20. A method for providing an accesser credit from a plurality of creditors, comprising:
receiving an accesser credit request;
receiving accesser credit history information;
transmitting accesser credit request and accesser credit history information to potential creditor;
receiving bids for partial fulfillment of the accesser credit request based on the accesser credit history information;
selecting more than one bid to fulfill the accesser credit request.

21. The method of claim 20, wherein the step of receiving accesser credit history information includes a step of receiving accesser credit rating.

22. The method of claim 20, wherein the step of receiving accesser credit history information includes a step of receiving accesser credit history information and receiving accesser credit rating.

23. The method of claim 20, further comprising providing credit issuance.

24. The method of claim 20, further comprising providing credit confirmation.

25. The method of claim 23, further comprising providing credit confirmation.

26. The method of claim 20, further comprising providing credit approval.

27. The method of claim 23, further comprising providing credit approval.

28. The method of claim 25, further comprising providing credit approval.

29. A system for providing an accesser credit from a plurality of creditors, comprising:
means for receiving an accesser credit request;
means for receiving accesser credit history information;
means for transmitting accesser credit request and acesser credit history information to potential creditors;
means for receiving bids from potential creditors for partial fulfillment of the accessers credit request based on the accesser credit history information;
means for selecting more than one potential creditor to fulfill accesser credit request.

30. The system of claim 29, wherein the means for receiving accesser credit history information is configured for receiving accesser credit rating.

31. The system of claim 29, wherein the means for receiving accesser credit history information is configured for receiving accesser credit history information and receiving accesser credit rating.

32. The system of claim 29, further comprising a means for providing credit issuance.

33. The system of claim 29, further comprising a means for providing credit confirmation.

34. The system of claim 32, further comprising a means for providing credit confirmation.

35. The system of claim 29, further comprising a means for providing credit approval.

36. The system of claim 32, further comprising a means for providing credit approval.

37. The system of claim 34, further comprising a means for providing credit approval.
